(19) United States
(12) Patent Application Publication
(10) Pub. No.: US 2026/0141854 A1
(43) Pub. Date: May 21, 2026

(54) PIXEL CIRCUIT AND DISPLAY DEVICE INCLUDING PIXEL CIRCUIT

(71) Applicant: Japan Display Inc., Tokyo (JP)

(72) Inventor: Tatsuya ISHII, Tokyo (JP)

(21) Appl. No.: 19/363,948

(22) Filed: Oct. 21, 2025

(30) Foreign Application Priority Data
Nov. 15, 2024 (JP) 2024-199597

(51) Int. Cl. G09G 3/3233

(52) U.S. Cl. CPC G09G 3/3233; G09G 2300/0426; G09G 2300/0465; G09G 2300/0819; G09G 2300/0852; G09G 2310/08

(57) ABSTRACT

A pixel circuit includes a first transistor controlled by a first control signal and electrically connected between an image data signal line supplied with a data potential and a gate electrode of a second transistor, the second transistor electrically connected to a first electrode of a first capacitive element, a sixth transistor controlled by a second control signal and electrically connected between a reference potential line supplied with a reference potential and a first electrode of a second capacitive element, the first capacitive element electrically connected between the first electrode of the second capacitive element and a first electrode of the second transistor, the second capacitive element electrically connected between a second electrode of the first capacitive element and the gate electrode, and a light-emitting element.

### CROSS-REFERENCE TO RELATED APPLICATIONS

This application claims the benefit of priority to Japanese Patent Application No. 2024-199597 filed on Nov. 15, 2024, the entire contents of which are incorporated herein by reference.

### FIELD

An embodiment of the present invention relates to a pixel circuit and a display device including the pixel circuit.

### BACKGROUND

In recent years, a display device including a light-emitting element has been mounted on a television, a smartphone, or the like, and is becoming popular. For example, the display device includes a plurality of pixels and a control circuit for driving the plurality of pixels. Each of the plurality of pixels includes a plurality of transistors, a capacitive element, and a light-emitting element. The light-emitting element is an element that emits light in a self-luminous manner (a self-luminous light-emitting element), and is, for example, a light-emitting diode (Light Emitting Diode: LED), a minute light-emitting diode (micro LED), or an organic electroluminescence (Electro Luminescence: EL) element. The control circuit in the display device can supply a potential to each of the plurality of pixels and allow a current corresponding to the supplied potential to flow to the light-emitting elements included in each of the plurality of pixels. Each of the light-emitting elements emits light with a luminance corresponding to a current flowing through the light-emitting element, and a pixel including the light-emitting element can display an image with a gradation corresponding to the luminance.

For example, a display device including a light-emitting element is known. A pixel in a display device including a light-emitting element includes nine transistors (T1 to T9), two capacitive elements (Chold, Cst) connected in series, and one light-emitting element (LED). In addition, a method for driving a display device including a light-emitting element includes electrically connecting a gate electrode (Gate) of the transistor T1 and a node (D-node) of one electrode side of the capacitive element Chold by the transistor T3 in an initializing period (Initialization period) and a light-emitting period (Light emitting period).

### SUMMARY

A pixel circuit includes a first transistor, a second transistor, a sixth transistor, a first capacitive element, a second capacitive element, a light-emitting element, an image data signal line supplied with a data potential, and a reference potential line supplied with a reference potential. The first transistor is controlled by a first control signal and is electrically connected between the image data signal line and a gate electrode of the second transistor, the second transistor is electrically connected to a first electrode of the first capacitive element, the sixth transistor is controlled by a second control signal and is electrically connected between the reference potential line and a first electrode of the second capacitive element, the first capacitive element is electrically connected between the first electrode of the second capacitive element and a first electrode of the second transistor, and the second capacitive element is electrically connected between a second electrode of the first capacitive element and the gate electrode of the second transistor.

A display device includes a plurality of pixels including a pixel circuit, and the plurality of pixels is arranged in a matrix in a first direction and a second direction intersecting the first direction. The pixel circuit includes a first transistor, a second transistor, a sixth transistor, a first capacitive element, a second capacitive element, a light-emitting element, an image data signal line supplied with a data potential, and a reference potential line supplied with a reference potential. The first transistor is controlled by a first control signal and is electrically connected between the image data signal line and a gate electrode of the second transistor, the second transistor is electrically connected to a first electrode of the first capacitive element, the sixth transistor is controlled by a second control signal and is electrically connected between the reference potential line and a first electrode of the second capacitive element, the first capacitive element is electrically connected between the first electrode of the second capacitive element and a first electrode of the second transistor, the second capacitive element is electrically connected between a second electrode of the first capacitive element and the gate electrode of the second transistor, the light-emitting element is electrically connected between a standard potential line supplied with a standard potential and the first electrode of the second transistor. The pixel circuit further includes a fifth transistor, a third transistor, a fourth transistor, a driving potential line supplied with a driving potential which is higher than the standard potential, a reset potential line supplied with a reset potential, and an initialization potential line supplied with an initialization potential. The fifth transistor is controlled by a third control signal, and is electrically connected between the reset potential line and a second electrode of the second transistor, the third transistor is controlled by a fourth control signal, and electrically connected between the reset potential line and the gate electrode of the second transistor, and the fourth transistor is controlled by a fifth control signal, and is electrically connected between the initialization potential line and the first electrode of the second transistor.

A pixel circuit includes a first transistor, a second transistor, a sixth transistor, a first capacitive element, a second capacitive element, a light-emitting element, an image data signal line supplied with a data potential, a reference potential line supplied with a reference potential, a fifth transistor, a standard potential line supplied with a standard potential, a third transistor, a fourth transistor, a seventh transistor, a reset potential line supplied with a reset potential, a constant potential line supplied with a constant potential, and a driving potential line supplied with a driving potential which is higher than the standard potential. The first transistor is controlled by a first control signal and is electrically connected between the image data signal line and a gate electrode of the second transistor, the second transistor is electrically connected to a first electrode of the first capacitive element, the sixth transistor is controlled by a second control signal and is electrically connected between the reference potential line and a first electrode of the second capacitive element, the first capacitive element is electrically connected between the first electrode of the second capacitive element and a first electrode of the second transistor, the second capacitive element is electrically connected between a second electrode of the first capacitive element and the gate electrode of the second transistor, the fifth transistor is controlled by a third control signal, and is electrically connected between a second electrode of the second transistor and a second electrode of the second capacitive element, the light-emitting element is electrically connected between the standard potential line and a first electrode of the fifth transistor, the third transistor is controlled by a fourth control signal, and is electrically connected between the reset potential line and the gate electrode of the second transistor, the fourth transistor is controlled by the first control signal, and is electrically connected between the constant potential line and the first electrode of the fifth transistor, the seventh transistor is controlled by a fifth control signal, and is electrically connected between the driving potential line and the first electrode of the second transistor, and the plurality of pixels is arranged in a matrix in a first direction and a second direction intersecting the first direction.

A display device includes a plurality of pixels including a pixel circuit, and the plurality of pixels is arranged in a matrix in a first direction and a second direction intersecting the first direction. The pixel circuit includes a first transistor, a second transistor, a sixth transistor, a first capacitive element, a second capacitive element, a light-emitting element, an image data signal line supplied with a data potential, and a reference potential line supplied with a reference potential. The first transistor is controlled by a first control signal and is electrically connected between the image data signal line and a gate electrode of the second transistor, the second transistor is electrically connected to a first electrode of the first capacitive element, the sixth transistor is controlled by a second control signal and is electrically connected between the reference potential line and a first electrode of the second capacitive element, the first capacitive element is electrically connected between the first electrode of the second capacitive element and a first electrode of the second transistor, the second capacitive element is electrically connected between a second electrode of the first capacitive element and the gate electrode of the second transistor. The pixel circuit further includes a fifth transistor, and a standard potential line supplied with a standard potential. The fifth transistor is controlled by a third control signal, and is electrically connected between a second electrode of the second transistor and a second electrode of the second capacitive element, and the light-emitting element is electrically connected between the standard potential line and a first electrode of the fifth transistor. The pixel circuit further includes a third transistor, a fourth transistor, a seventh transistor, a reset potential line supplied with a reset potential, a constant potential line supplied with a constant potential, and a driving potential line supplied with a driving potential which is higher than the standard potential. The third transistor is controlled by a fourth control signal, and is electrically connected between the reset potential line and the gate electrode of the second transistor, the fourth transistor is controlled by the first control signal, and is electrically connected between the constant potential line and the first electrode of the fifth transistor, and the seventh transistor is controlled by a fifth control signal, and is electrically connected between the driving potential line and the first electrode of the second transistor.

### BRIEF DESCRIPTION OF DRAWINGS

FIG. 1 is a schematic diagram showing a configuration of a display device according to a first embodiment of the present invention.

FIG. 2 is a schematic diagram showing an input signal to a pixel circuit according to the first embodiment of the present invention.

FIG. 3 is a circuit diagram showing a configuration of the pixel circuit according to the first embodiment of the present invention.

FIG. 4 is a timing chart of the display device according to the first embodiment of the present invention.

FIG. 5 is a timing chart of the display device according to the first embodiment of the present invention.

FIG. 6 is a timing chart of the display device according to the first embodiment of the present invention.

FIG. 7 is a timing chart of the display device according to the first embodiment of the present invention.

FIG. 8 is a timing chart of the display device according to the first embodiment of the present invention.

FIG. 9 is a layout diagram of a pixel according to the first embodiment of the present invention.

FIG. 10 is a layout diagram of the pixel according to the first embodiment of the present invention.

FIG. 11 is an end view showing an end face cut along A1-A2 in the layout shown in FIG. 9.

FIG. 12 is an end view showing an end face cut along B1-B2 in the layout shown in FIG. 9.

FIG. 13 is an end view showing a modification of the end face cut along A1-A2 in the layout shown in FIG. 9.

FIG. 14 is a sequence diagram showing a method for manufacturing the display device according to the first embodiment of the present invention.

FIG. 15 is a layout diagram of the pixel according to the first embodiment of the present invention.

FIG. 16 is a layout diagram of the pixel according to the first embodiment of the present invention.

FIG. 17 is a layout diagram of the pixel according to the first embodiment of the present invention.

FIG. 18 is a schematic diagram showing a configuration of a display device according to a second embodiment of the present invention.

FIG. 19 is a schematic diagram showing an input signal to a pixel circuit according to the second embodiment of the present invention.

FIG. 20 is a circuit diagram showing a configuration of the pixel circuit according to the second embodiment of the present invention.

FIG. 21 is a timing chart of the display device according to the second embodiment of the present invention.

FIG. 22 is a timing chart of the display device according to the second embodiment of the present invention.

FIG. 23 is a timing chart of a control circuit according to the second embodiment of the present invention.

FIG. 24 is a timing chart of the pixel circuit according to the second embodiment of the present invention.

### DESCRIPTION OF EMBODIMENTS

Hereinafter, embodiments of the present invention will be described with reference to the drawings and the like. However, the present invention can be implemented in many different aspects, and should not be construed as being limited to the description of the embodiments exemplified below. Further, in order to make the description clearer, the drawings may be schematically represented with respect to the width, thickness, shape, configuration, and the like of each part as compared with the actual embodiment, but they are merely examples, and do not limit the interpretation of the present invention. It should be noted that the terms “first” and “second” for each element are convenient labels used to distinguish each element, and do not have any further meaning unless otherwise described.

Also, in the present specification, the expression “a includes A, B, or C,” “a includes any of A, B, and C,” “a includes one selected from the group consisting of A, B, and C,” and the like does not exclude cases where a includes a plurality of combinations of A to C unless otherwise specified. Furthermore, these expressions do not exclude the case where a includes other elements.

In one embodiment, a first direction D1 intersects a second direction D2 and a third direction D3 intersects the first direction D1 and the second direction D2 (a plane D1D2).

In the case where the “same (identical)” and “match” are used in the specification of this application, the “same” and “match” may include errors within the scope of the design. In addition, in one embodiment of the present invention, in the case where an error in the range of design is included, the expression “substantially the same” and “substantially match” may be used in some cases.

An LED, a micro LED, an EL element, or the like can be used as a self-luminous light-emitting element in one embodiment of the present disclosure. In addition, the light-emitting device of the self-luminous type is not limited to the LED, the micro LED, and the EL element. For example, a display device according to one embodiment of the present disclosure is a display device using the EL element as a self-luminous light-emitting element. For example, a display device using the EL element may be referred to as a self-luminous display device, an EL display device, or the like.

### 1. First Embodiment

### 1-1. Overview of Display Device 10

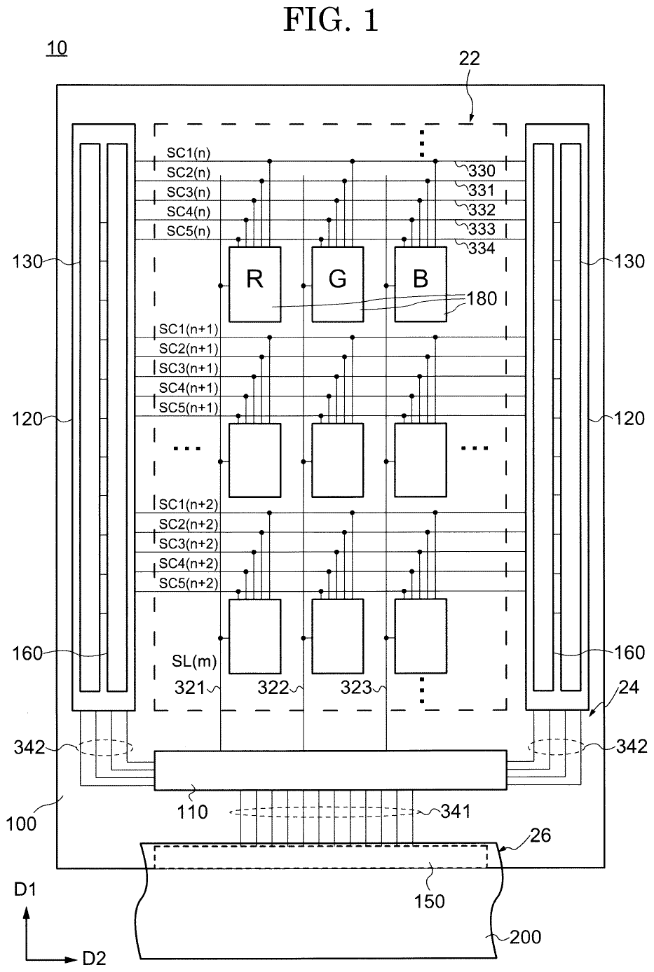

An overview of a display device 10 according to a first embodiment will be described with reference to FIG. 1. FIG. 1 is a schematic diagram showing a configuration of the display device 10. The configuration of the display device 10 shown in FIG. 1 is an example, and the configuration of the display device 10 is not limited to the configuration shown in FIG. 1.

The display device 10 includes an array substrate 100, a flexible printed circuit board 200 (FPC 200), and an IC chip 110. The display device 10 includes a display area 22 that overlaps the array substrate 100, a peripheral area 24 that surrounds the display area 22, and a terminal area 26.

In the display area 22, a plurality of pixels 180 is arranged in a matrix along the first direction D1 (column direction) and the second direction D2 (row direction) intersecting the first direction D1. The pixel 180 is the smallest unit constituting a part of the image to be displayed in the display area 22. Each of the plurality of pixels 180 may correspond to, for example, a sub-pixel R, a sub-pixel G, and a sub-pixel B. One pixel may be formed by three sub-pixels. Arrangement of the plurality of pixels 180 is not limited, and the arrangement of the plurality of pixels 180 may be a delta arrangement, a pentile arrangement, or the like. For example, the arrangement of the plurality of pixels 180 of the display device 10 is a stripe arrangement.

The sub-pixel R, the sub-pixel G, and the sub-pixel B are configured to display images of different colors. For example, each of the sub-pixel R, the sub-pixel G, and the sub-pixel B includes a light-emitting element including a light-emitting layer that emits red, green, and blue. An arbitrary potential or current is supplied to each of the three sub-pixels, and the display device 10 can display an image.

The peripheral area 24 is provided with the IC chip 110 and two control circuits 120. The two control circuits 120 are provided on the left and right sides of the display area 22. The IC chip 110 is connected to a terminal portion 150 using a connection wiring 341. Each of the two control circuits 120 is connected to the IC chip 110 using a connection wiring 342. The peripheral area 24 may be referred to as a frame area. The connection wiring 341 may be referred to as the connection wiring 341 alone, and a bundle of a plurality of connection wirings 341 may be referred to as the connection wiring 341. In the same manner as the connection wiring 341, the connection wiring 342 may be referred to as the connection wiring 342 alone, and a bundle of a plurality of connection wirings 342 may be referred to as the connection wiring 342.

The terminal area 26 is provided with the terminal portion 150 and the FPC 200 electrically connected to the terminal portion 150. The terminal area 26 is an area opposed to an area where the display area 22 is provided with respect to the peripheral area 24 along the first direction D1.

The FPC 200 is connected to an external device (not shown) outside the display device 10. The display device 10 is connected to an external device via the FPC 200 and the terminal portion 150. A control signal and a potential are transmitted from the external device to the display device 10 via the FPC 200 and the terminal portion 150. The display device 10 drives each pixel 180 provided in the display device 10 by using the received control signal and potential from the external device. As a result, the display device 10 can display an image in the display area 22.

The IC chip 110 supplies signals, potentials, and the like for driving the respective pixels 180 to the two control circuits 120 and the respective pixels 180 (pixel circuits 181) via the FPC 200, the terminal portion 150, and the connection wiring 341.

Each of the IC chip 110 and the two control circuits 120 may be referred to as a control circuit alone, and a circuit group including a part or all of each of the IC chip 110 and the two control circuits 120 may be referred to as the control circuit.

### 1-2. Configuration of IC Chip 110

Referring to FIG. 1, an overview of the IC chip 110 will be described. The IC chip 110 is provided at a position adjoining the display area 22 along the first direction D1. Image data signal lines 321, 322, and 323 extend from the IC chip 110 in the first direction D1 and are connected to the plurality of pixels 180 arranged in the first direction D1.

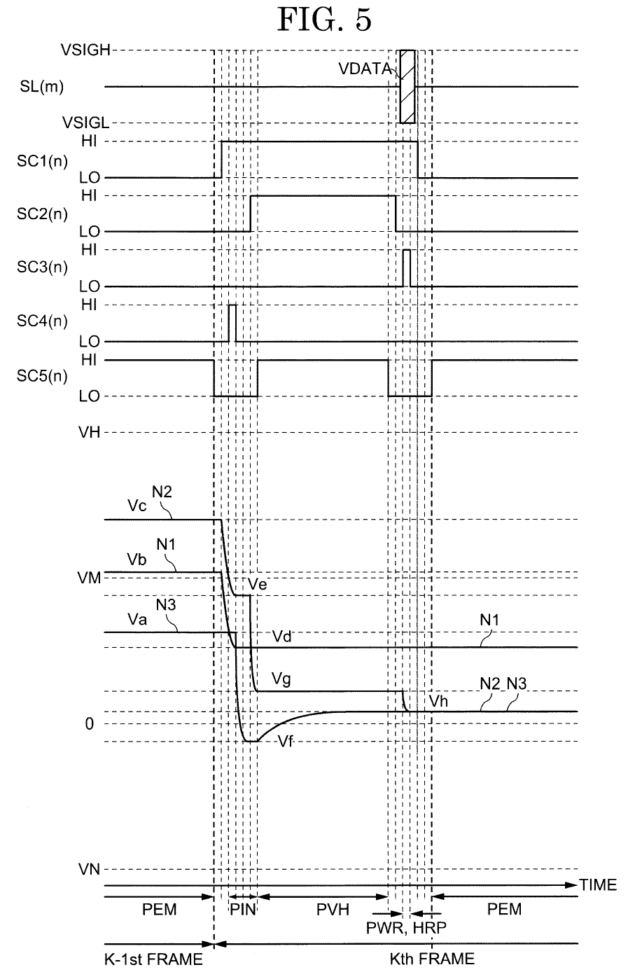

For example, the IC chip 110 includes a plurality of selection circuits (not shown). For example, each of the plurality of selection circuits is a switch controlled based on an on signal and an off signal supplied to the selection signal. The selection circuit is selected by the on signal supplied to the selection signal and supplies the image data signal SL(m) including a data signal VDATA to the image data signal line 321 and the pixel 180 electrically connected to the image data signal line 321. For example, the selection signal and the image data signal SL(m) are transmitted by a digital signal from an external device to the IC chip 110 via the FPC 200 and the terminal portion 150. Further, for example, the data signal VDATA (image data signal SL(m)) is DA (digital-analog) converted by the IC chip 110 into an analog signal including a data potential equal to or higher than a potential VSIGL (see FIG. 5) and equal to or lower than a potential VSIGH (see FIG. 5). The potential VSIGH is a potential higher than the potential VSIGL.

For example, the on signal is a signal including a potential that conducts the selection circuit (switch), and the off signal is a signal including a potential that blocks the selection circuit (switch). In the present disclosure, the on signal may be a high level potential (high, High, HI), the off signal may be a low level potential (low, Low, LO), the on signal may be a low level potential (low, Low, LO), and the off signal may be a high level potential (high, High, HI). The high level potential is higher than the low level potential. In the display device according to one embodiment of the present specification, as an example, the on signal is a high-level potential and the off signal is a low-level potential.

### 1-3. Configuration of Control Circuit 120

An overview of the control circuit 120 will be described with reference to FIG. 1. The two control circuits 120 are provided at positions adjoining both sides of the display area 22 along the second direction D2. A scan signal line 330, a scan signal line 331, a scan signal line 332, a scan signal line 333, and a scan signal line 334 extend from the control circuit 120 in the second direction D2 and are connected to the plurality of pixels 180 arranged in the second direction D2. For example, each scan signal line of the display device 10 shown in FIG. 1 is connected to both of the two control circuits 120. Each scan signal line may be connected to one control circuit 120 of the two control circuits 120. For example, an n-th scan signal line may be electrically connected to the control circuit 120 on the right side of the display area 22 along the second direction D2, and an n+1-th scan signal line may be electrically connected to the control circuit 120 on the left side of the display area 22 along the second direction D2. The number n is a positive integer.

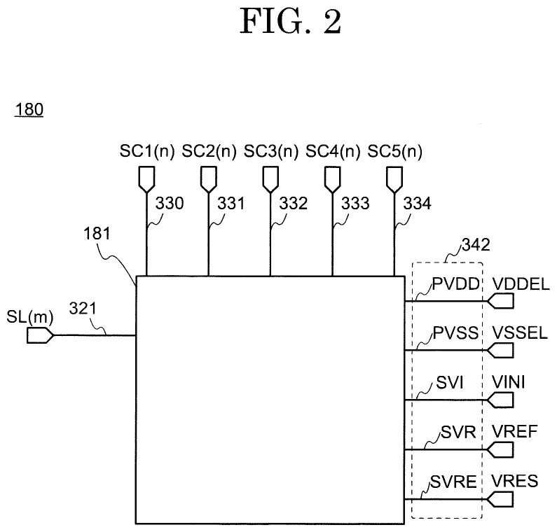

The control circuit 120 includes a shift register circuit 130 and a scan driver circuit 160. For example, the control circuit 120 is a gate driver, and receives a control signal including a clock signal, a start pulse, a plurality of enable signals, and the like, and potentials such as a driving potential VDDEL (see FIG. 2) and a standard potential VSSEL (see FIG. 2). The control circuit 120 can sequentially select the scanning lines according to inputs of the control signal and the power supply.

The shift register circuit 130 is electrically connected to the scan driver circuit 160. The shift register circuit 130 includes a plurality of shift registers (not shown). Further, the plurality of control signals described above are supplied to the shift register circuit 130 via the plurality of connection wirings 342, the driving potential VDDEL is supplied via a driving potential line PVDD (see FIG. 2), and the standard potential VSSEL is supplied via a standard potential line PVSS (see FIG. 2). The shift register circuit 130 has a role of generating a plurality of output signals (not shown) shifted at different timings based on the plurality of control signals described above, and sequentially outputting the output signals to the scan driver circuit 160.

The scan driver circuit 160 includes a plurality of scan drivers (not shown). For example, the plurality of scan drivers is supplied with a plurality of output signals from the shift register circuit 130, the plurality of enable signals described above are supplied from the IC chip 110 via the plurality of connection wirings 342, the driving potential VDDEL is supplied via the driving potential line PVDD, and the standard potential VSSEL is supplied via the standard potential line PVSS. The plurality of scan drivers, based on a plurality of output signals and a plurality of enable signals (not shown), are configured to sequentially supply scan signals having different timings (for example, a first scan signal SC1(n), a second scan signal SC2(n), a third scan signal SC3(n), a fourth scan signal SC4(n), and a fifth scan signal SC5(n)) to the respective scan signal lines, and to drive pixels 180 (pixel circuits 181) electrically connected to the respective scan signal lines. For example, the third scan signal SC3(n) and the scan signal line 332 to which the third scan signal SC3(n) is supplied are a so-called scan signal and scan signal line.

### 1-4. Configuration of Pixel 180

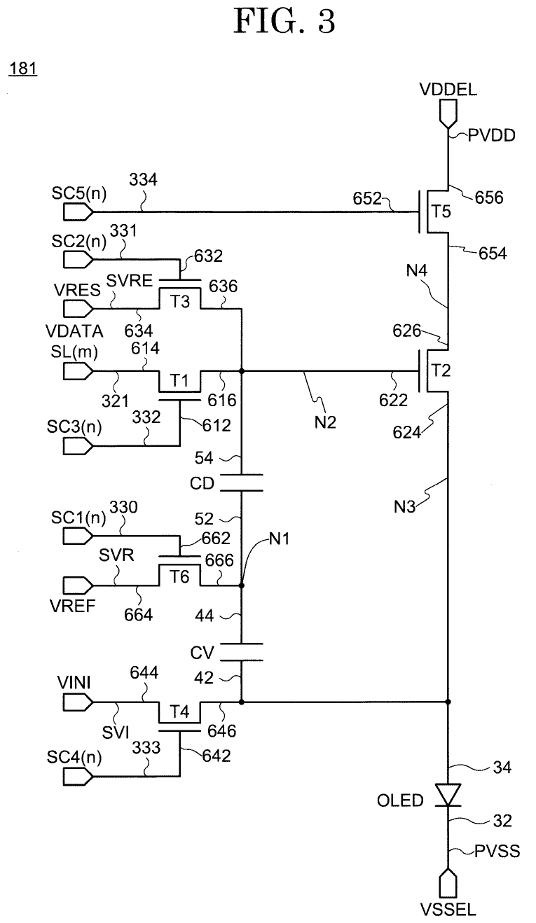

Referring to FIG. 1 to FIG. 3, an overview of the pixel 180 and the pixel circuit 181 will be described. FIG. 2 is a schematic diagram showing an input signal to the pixel circuit 181 included in the pixel 180. FIG. 3 is a circuit diagram showing a configuration of the pixel circuit 181. As an example, FIG. 2 and FIG. 3 show the configuration of the pixel circuit 181 of the pixel 180 shown in FIG. 1. The configuration of the pixel 180 and the pixel circuit 181 is not limited to the configuration shown in FIG. 1 to FIG. 3. Configurations that are the same as or similar to those in FIG. 1 are described as necessary, and descriptions of the same or similar configurations as those in FIG. 1 may be omitted.

The pixel circuit 181 is a circuit for driving the pixel 180. The pixel circuits of the sub-pixel R, the sub-pixel G, and the sub-pixel B included in the pixel 180 are the same as those of the pixel circuit 181, and differ in the colors emitted by the light-emitting elements OLED. In the following explanation, a light-emitting element OLED that emits red light will be described as an example.

As shown in FIG. 2, the pixel circuit 181 is supplied with the image data signal SL(m), the first scan signal SC1(n), the second scan signal SC2(n), the third scan signal SC3(n), the fourth scan signal SC4(n), the fifth scan signal SC5(n), a reset potential VRES, a reference potential VREF, and an initialization potential VINI. Further, as a power source for driving the pixel 180, the driving potential VDDEL and the standard potential VSSEL are supplied to the pixel circuit 181. For example, the reset potential VRES, the reference potential VREF, the initialization potential VINI, the driving potential VDDEL, and the standard potential VSSEL may be constant potentials, and may be variable potentials that vary depending on the timings of the respective signals.

The first scan signal SC1(n) is supplied to the scan signal line 330, the second scan signal SC2(n) is supplied to the scan signal line 331, the third scan signal SC3(n) is supplied to the scan signal line 332, the fourth scan signal SC4(n) is supplied to the scan signal line 333, and the fifth scan signal SC5(n) is supplied to the scan signal line 334. The first scan signal SC1(n) may be referred to as a second control signal, the second scan signal SC2(n) may be referred to as a fourth control signal, the third scan signal SC3(n) may be referred to as a first control signal, the fourth scan signal SC4(n) may be referred to as a fifth control signal, and the fifth scan signal SC5(n) may be referred to as a third control signal.

Further, the reset potential VRES is supplied to a reset potential line SVRE, the reference potential VREF is supplied to the reference potential line SVR, the initialization potential VINI is supplied to an initialization potential line SVI, the driving potential VDDEL is supplied to the driving potential line PVDD, and the standard potential VSSEL is supplied to the standard potential line PVSS. For example, the reset potential line SVRE, the reference potential line SVR, the initialization potential line SVI, the driving potential line PVDD, and the standard potential line PVSS are electrically connected to the connection wiring 342. Further, for example, each of the reset potential line SVRE, the reference potential line SVR, the initialization potential line SVI, the driving potential line PVDD, and the standard potential line PVSS may be connected to different connection wirings 342.

For example, the reset potential VRES, the reference potential VREF, the initialization potential VINI, the driving potential VDDEL, and the standard potential VSSEL may be supplied from an external device to the IC chip 110 via the FPC 200, the terminal portion 150, and the connection wiring 341. Further, for example, the reset potential VRES, the reference potential VREF, the initialization potential VINI, the driving potential VDDEL, and the standard potential VSSEL may be generated by the IC chip 110, and may be supplied to the plurality of pixels 180 (the pixel circuit 181) via the connection wiring 342, the reset potential line SVRE, the reference potential line SVR, the initialization potential line SVI, the driving potential line PVDD, and the standard potential line PVSS from the IC chip 110. In addition, although not shown, the reset potential VRES, the reference potential VREF, the initialization potential VINI, the driving potential VDDEL, and the standard potential VSSEL may be connected to the reset potential line SVRE, the reference potential line SVR, the initialization potential line SVI, the driving potential line PVDD, and the standard potential line PVSS via the FPC 200, the terminal portion 150, and the connection wiring 341, without passing through the IC chip 110 and the connection wiring 342 from the external device, and may be supplied to the plurality of pixels 180 (pixel circuit 181). For example, the reset potential VRES, the reference potential VREF, the initialization potential VINI, and the standard potential VSSEL are lower than the driving potential VDDEL.

As shown in FIG. 3, the pixel 180 (pixel circuit 181) includes a first transistor T1, a second transistor T2, a third transistor T3, a fourth transistor T4, a fifth transistor T5, a sixth transistor T6, a capacitive element CV, a capacitive element CD, and a light-emitting element OLED. Each of these transistors includes a gate electrode and a pair of electrodes (a source electrode and a drain electrode) including a first electrode and a second electrode. Each of the capacitive element CV, the capacitive element CD, and the light-emitting element OLED has a pair of electrodes including a first electrode and a second electrode. In addition, the capacitive element CV may be referred to as a first capacitive element, and the capacitive element CD may be referred to as a second capacitive element.

For example, the first transistor T1 is a selection transistor. The first transistor T1 has a function of supplying the image data signal SL(m) to the second node N2.

For example, the second transistor T2 is a driving transistor. As will be described later, a threshold voltage (a potential difference Vgs that becomes a threshold value) VTH is acquired between a first node N1 and a first electrode (source) 624 based on the reset potential VRES. The acquired threshold voltage VTH is applied to the capacitive element CV, whereby the threshold voltage VTH is acquired and held (stored). Further, the second transistor T2 controls the amount of current flowing from the driving potential line PVDD to the light-emitting element OLED based on a gate potential (a potential between a gate electrode 622 and the first electrode 624) and the input image data signal SL(m) in which the variation in the threshold voltage VTH is corrected. That is, the second transistor T2 has a function of causing the light-emitting element OLED to emit light by causing a current corresponding to a display gradation (luminance) of the light-emitting element OLED to flow from the driving potential VDDEL to the light-emitting element OLED.

For example, the third transistor T3 has a function of conducting the second node N2 and the reset potential line SVRE, supplying the reset potential VRES to the second node N2, and fixing the potential supplied to the second node N2 to the reset potential VRES. As will be described later, if the potential supplied to the second node N2 is fixed to the reset potential VRES, a current flows from the driving potential line PVDD to a fifth node N5, a fourth node N4, and a third node N3 via the fifth transistor T5, and the capacitance element CV (a first electrode 42 of the capacitance element CV) starts to be charged, and if the potential difference Vgs (the potential difference Vgs between a potential supplied to the gate electrode 622 (the second node N2) and a potential supplied to the first electrode 624 (the third node N3)) reaches the threshold voltage VTH, the charging is stopped.

The fourth transistor T4 has a function of conducting the third node N3 and the initialization potential line SVI, supplying the initialization potential VINI to the third node N3, and initializing the third node N3.

The fifth transistor T5 has a function of conducting the driving potential line PVDD and the fourth node N4.

The sixth transistor T6 has a function of conducting the first node N1 and the reference potential line SVR, supplying the reference potential VREF to the first node N1, and fixing the potential supplied to the first node N1 to the reference potential VREF at the time of initialization of the third node N3, at the time of acquiring and holding the threshold voltage VTH, and at the time of writing the image data signal SL(m).

The capacitive element CV has a function of holding (storing) charges corresponding to the threshold voltage VTH of the second transistor T2. That is, the capacitive element CV has a function of holding (storing) a potential difference between the potential supplied to the first node N1 and the potential supplied to the third node N3, including information of the threshold voltage VTH of the second transistor T2. A method for driving the display device 10 includes acquiring the threshold voltage VTH by applying the driving potential VDDEL from the second electrode 626 (drain electrode) of the second transistor T2 via the driving potential line PVDD.

The capacitive element CD has a function of holding (storing) charges corresponding to data potentials (potentials equal to or higher than the potential VSIGL (see FIG. 5) and equal to or lower than the potential VSIGH (see FIG. 5)) included in the image data signal SL(m) supplied to the second node N2. That is, the capacitive element CD has a function of holding (storing) a potential difference between the potential supplied to the second node N2 and the potential supplied to the first node N1, including data potential information of the image data signal SL(m).

The light-emitting element OLED has a diode characteristic and has a function of emitting light based on a current flowing through the light-emitting element OLED. The current flowing through the light-emitting element OLED is the drain current (a current Ion) of the second transistor T2.

The first transistor T1 includes a gate electrode 612, a first electrode 614, and a second electrode 616. The gate electrode 612 is electrically connected to the scan signal line 332. The first electrode 614 is electrically connected to the image data signal line 321. The second electrode 616 is electrically connected to the second node N2, the gate electrode 622 of the second transistor T2, a second electrode 636 of the third transistor T3, and a second electrode 54 of the capacitive element CD. The first transistor T1 is switched using the third scan signal SC3(n). In other words, in the first transistor T1, a conduction state (on state) and a non-conduction state (off state) are controlled by the third scan signal SC3(n). If the signal supplied to the third scan signal SC3(n) is LO, the first transistor T1 becomes non-conductive. If the signal supplied to the third scan signal SC3(n) is HI, the first transistor T1 becomes conductive.

The second transistor T2 includes the gate electrode 622, the first electrode 624, and a second electrode 626. The first electrode 624 is electrically connected to the third node N3, the first electrode 42 of the capacitive element CV, and a second electrode 34 of the light-emitting element OLED. The second electrode 626 is electrically connected to the fourth node N4 and a first electrode 654 of the fifth transistor T5. The threshold voltage of the second transistor T2 is the threshold voltage VTH. The second transistor T2 controls the current flowing through the light-emitting element OLED in accordance with the potential difference Vgs and a potential difference Vds between a potential supplied to the second electrode 626 (the fourth node N4) and a potential supplied to the first electrode 624 (the third node N3). For example, if the potential difference Vgs is smaller than the threshold voltage VTH, the second transistor T2 becomes non-conductive. In this case, since no current flows through the light-emitting element OLED, the pixel 180 displays black. For example, when the potential difference Vgs is equal to or higher than the threshold voltage VTH and the potential difference Vds is larger than 0 V, the second transistor T2 becomes conductive, and the current flowing through the light-emitting element OLED is controlled according to a magnitude based on the gradation of the display of the potential difference Vgs, and the light-emitting element OLED emits light with the luminance based on the gradation of the display.

The third transistor T3 includes a gate electrode 632, a first electrode 634, and the second electrode 636. The gate electrode 632 is electrically connected to the scan signal line 331. The first electrode 634 is electrically connected to the reset potential line SVRE. The third transistor T3 is switched using the second scan signal SC2(n). In other words, in the third transistor T3, the conduction state (on state) and the non-conduction state (off state) are controlled by the second scan signal SC2(n). If the signal supplied to the second scan signal SC2(n) is LO, the third transistor T3 becomes non-conductive, and if the signal supplied to the second scan signal SC2(n) is HI, the third transistor T3 becomes conductive.

The fourth transistor T4 includes a gate electrode 642, a first electrode 644, and a second electrode 646. The gate electrode 642 is electrically connected to the scan signal line 333. The first electrode 644 is electrically connected to the initialization potential line SVI. The fourth transistor T4 is switched using the fourth scan signal SC4(n). In other words, in the fourth transistor T4, the conduction state (on state) and the non-conduction state (off state) are controlled by the fourth scan signal SC4(n). If the signal supplied to the fourth scan signal SC4(n) is LO, the fourth transistor T4 becomes non-conductive, and if the signal supplied to the fourth scan signal SC4(n) is HI, the fourth transistor T4 becomes conductive.

The fifth transistor T5 includes a gate electrode 652, the first electrode 654, and a second electrode 656. The gate electrode 652 is electrically connected to the scan signal line 334. The second electrode 656 is electrically connected to the driving potential line PVDD. The fifth transistor T5 is switched using the fifth scan signal SC5(n). In other words, in the fifth transistor T5, the conduction state (on state) and the non-conduction state (off state) are controlled by the fifth scan signal SC5(n). If the signal supplied to the fifth scan signal SC5(n) is LO, the fifth transistor T5 becomes non-conductive, and if the signal supplied to the fifth scan signal SC5(n) is HI, the fifth transistor T5 becomes conductive.

The sixth transistor T6 includes a gate electrode 662, a first electrode 664, and a second electrode 666. The gate electrode 662 is electrically connected to the scan signal line 330. The first electrode 664 is electrically connected to the reference potential line SVR. The second electrode 666 is electrically connected to the first node N1, a second electrode 44 of the capacitive element CV, and a first electrode 52 of the capacitive element CD. The sixth transistor T6 is switched using the first scan signal SC1(n). In other words, in the sixth transistor T6, the conduction state (on state) and the non-conduction state (off state) are controlled by the first scan signal SC1(n). If the signal supplied to the first scan signal SC1(n) is LO, the sixth transistor T6 becomes non-conductive, and if the signal supplied to the first scan signal SC1(n) is HI, the sixth transistor T6 becomes conductive.

The capacitive element CV includes the first electrode 42 and the second electrode 44.

The capacitive element CD includes the first electrode 52 and the second electrode 54.

A first electrode 32 of the light-emitting element OLED is a cathode, and the second electrode 34 of the light-emitting element OLED is an anode. The first electrode 32 is electrically connected to the standard potential line PVSS.

For example, it is assumed that the conductive state of the transistor in the display device 10 indicates a state in which the source electrode and the drain electrode of the transistor are conductive and the transistor is on (ON), and the non-conductive state of the transistor in the display device 10 indicates a state in which the source electrode and the drain electrode of the transistor are non-conductive and the transistor is off (OFF). In addition, in each transistor, the source electrode and the drain electrode may be replaced depending on the potential or potential supplied to each electrode. In addition, even if the transistor is in the off state, it can be easily understood by a person skilled in the art that a slight current flows, such as a leakage current.

Each transistor shown in FIG. 3 is an n-channel field effect transistor. Each transistor includes a channel region. For example, a channel region is a region through which a current flows between a first electrode (which may be referred to as a drain or drain electrode, for example) and a second electrode (which may be referred to as a source or source electrode, for example) of each transistor. As will be described in detail later, for example, the channel region includes a Group 14 element such as silicon or germanium, or an oxide exhibiting semiconductor characteristics. Further, for example, the transistors in the display device 10 are formed using a thin film transistor (TFT). The display device 10 may appropriately adapt the configuration of the transistor, connection of the storage capacitive element, a power supply potential, and the like according to the application and specifications.

### 1-5. Driving Method of Display Device 10

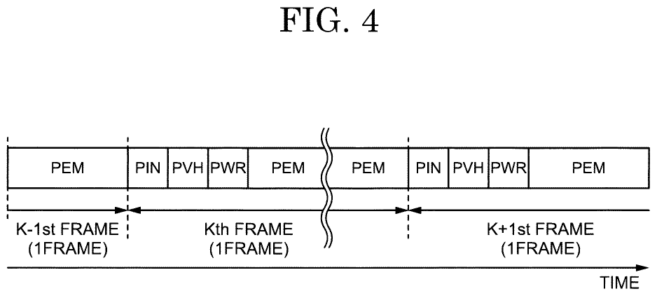

A method for driving the display device 10 will be described with reference to FIG. 4 to FIG. 8. FIG. 4 to FIG. 8 are schematic diagrams showing timing charts of the display device 10. Configurations that are the same as or similar to those in FIG. 1 to FIG. 3 are described as necessary, and descriptions of configurations that are the same as or similar to those in FIG. 1 to FIG. 3 may be omitted.

In addition, the horizontal axis of the timing charts in the respective embodiments represents time (TIME). Further, in the image data signal SL(m) including the data signal VDATA in the respective embodiments, for example, the data signal VDATA supplied to the selected pixel (pixel circuit) is indicated by a hatched line as a data potential equal to or higher than the potential VSIGL and equal to or lower than the potential VSIGH, and the data signal VDATA supplied to a pixel (pixel circuit) other than the selected pixel (pixel circuit) is omitted and indicated by a solid line. In practice, the potential of the data signal VDATA supplied to the pixels (pixel circuits) other than the selected pixels (pixel circuits) is also continuously or intermittently supplied to the image data signal SL(m) including the data signal VDATA in the respective embodiments.

For example, a frequency at which the display device 10 is driven is 60 Hz, and one frame (1 FRAME) is driven at 60 Hz. For example, FIG. 4 shows a current frame (Kth FRAME), a part of a previous frame (K−1st FRAME) of the current frame, and a part of a frame (K+1st FRAME) after the current frame. Also, FIG. 5 to FIG. 8 show a light emitting period PEM of the previous frame (K−1st FRAME) of the current frame, a period PIN, a period PVH, a period PWR, and a period PEM of the current frame (Kth FRAME), and a period PIN, a period PVH, a period PWR and a period PEM of the subsequent frame of the current frame. Further, FIG. 5 to FIG. 8 show one horizontal period (a horizontal period HRP) for one pixel 180 (pixel circuit 181).

First, an overview of the method for driving the display device 10 will be described with reference to FIG. 4. As shown in FIG. 4, the driving method of the display device 10 includes at least an initialization period PIN (period PIN), a threshold voltage acquiring and holding period PVH (period PVH), and a write period PWR (period PWR) in one frame. In the pixel 180 (pixel circuit 181) included in the display device 10, the period PWR is executed after the period PVH. Further, after the light emitting period PEM of the previous frame of the current frame, the period PIN, the period PVH, and the period PWR of the current frame are executed, and after the light emitting period PEM of the current frame, the period PIN, the period PVH, and the period PWR of the subsequent frame of the current frame are executed.

For example, the period PIN is a period in which the first node N1, the second node N2, and the third node N3 are initialized. The period PVH is a period in which the threshold voltage of the second transistor T2 is acquired by performing an operation in which the potential difference Vgs of the second transistor T2 becomes equal to the threshold voltage, and charges corresponding to the threshold voltage are held in the capacitive element CV. The period PWR is a period in which the data signal VDATA is written to the pixel 180 (the pixel circuit 181). That is, the period PWR is a period in which the data potential is supplied to the second node N2 and charges corresponding to the data potential are held in the capacitive element CD. Further, the light emitting period PEM is a period in which the pixel 180 emits light based on the written data potential and the acquired threshold voltage of the second transistor T2 (threshold voltage correction).

Next, a specific method for driving the pixel 180 (the pixel circuit 181) of the display device 10 will be described with reference to FIG. 4 to FIG. 8.

The pixel 180 (pixel circuit 181) receives the first scan signal SC1(n), the second scan signal SC2(n), the third scan signal SC3(n), the fourth scan signal SC4(n), the fifth scan signal SC5(n), the image data signal SL(m) including the data signal VDATA, the reset potential VRES, the initialization potential VINI, and the reference potential VREF. For example, the pixel 180 (pixel circuit 181) is selected according to timings of the first scan signal SC1(n), the second scan signal SC2(n), the third scan signal SC3(n), the fourth scan signal SC4(n), and the fifth scan signal SC5(n). The image data signal SL(m), the reset potential VRES, the initialization potential VINI, and the reference potential VREF are input to the selected pixel 180 (pixel circuit 181) in accordance with the timings of the respective signals. A similar operation is performed on all the pixels 180 (the pixel circuit 181), and an image of the frame corresponding to 1 FRAME is displayed in the display area 22 of the display device 10 on the basis of the image data signal SL(m) input to all the pixels 180 (the pixel circuit 181).

For example, the potentials supplied to each signal and each node in each period of each frame of the timing charts shown in FIG. 4 to FIG. 8 are shown in Table 1.

TABLE 1

| | Setting value [V] |
|---|---|
| VTH | 1 |
| VDDEL | 8 |
| VSSEL | 0 |
| HI | 10 |
| LO | −2 |
| VRES | 1.4 |
| VREF | 2.6 |
| VINI | −0.6 |
| VSIGL(black) | 0.4 |
| VSIGH(white) | 4.4 |

For example, as shown in Table 1, the threshold voltage VTH of the second transistor T2 is 1 V, the standard potential VSSEL is 0 V, the driving potential VDDEL is 8 V, the potential VH (HI) is 10 V, and the potential VL (LO) is −2 V. The reset potential VRES is 1.4 V, the reference potential VREF is 2.6 V, and the initialization potential VINI is −0.6 V. The potential VSIGL is 0.4 V, and the pixel 180 to which the potential VSIGL is supplied does not emit light and becomes black. Further, for example, the potential VSIGH is 4.4 V, and the pixel 180 to which the potential VSIGH is supplied emits light and emits white color. That is, the reference potential VREF is different from the reset potential VRES, and the reference potential VREF and the reset potential VRES are higher than the standard potential VSSEL and lower than the driving potential VDDEL. The initialization potential VINI is lower than the standard potential VSSEL. In addition, each potential shown in Table 1 is an example, and each potential of the display device 10 is not limited to each potential shown in Table 1. Each potential of the display device 10 can be appropriately selected according to the application and specifications of the display device 10.

### 1-5-1. First Example of Driving Method of Display Device 10

A first example of the method for driving the display device 10 will be described with reference to FIG. 5 and Table 1. The driving method shown in the first embodiment includes displaying a black image based on the potential VSIGL of the data signal VDATA at the Kth FRAME after the pixel 180 (the pixel circuit 181) displays a white image based on the potential VSIGH of the data signal VDATA at the previous frame (K−1st FRAME) of the current frame (Kth FRAME), and then displaying a black image based on the potential VSIGL of the data signal 180 (the pixel circuit 181). In other words, the driving method shown in the first example includes displaying images of different colors in successive frames.

The image data signal SL(m) including the data signal VDATA is input to each pixel 180 (pixel circuit 181) in accordance with each period. The data signal VDATA is analog data (analog potential) including a potential that is greater than or equal to the potential VSIGL and less than or equal to the potential VSIGH. For example, in the period PWR, a potential equal to or higher than the potential VSIGL and equal to or lower than the potential VSIGH is selected by using a selection signal (not shown), and is supplied to the image data signal SL(m). For example, in a period excluding the period PWR, the data signal VDATA is supplied with a potential that is supplied to pixels other than the selected pixel 180 (the pixel circuit 181).

The light emitting period PEM of the K−1st FRAME is a period in which the pixel 180 (the pixel circuit 181) emits light in accordance with the potential difference Vgs of the second transistor T2. For example, the pixel 180 (the pixel circuit 181) emits red light, and emits white light in three pixels using the pixel 180 emitting red light, the pixel 180 emitting blue light, and the pixel 180 emitting green light.

For example, in the light emitting period PEM of the K−1st FRAME, the image data signal SL(m) (data signal VDATA) is supplied with the potential of the data signal VDATA supplied to pixels other than the selected pixel 180 (pixel circuit 181), the first scan signal SC1(n), the second scan signal SC2(n), the third scan signal SC3(n), and the fourth scan signal SC4(n) are supplied with LO, and the fifth scan signal SC5(n) is supplied with HI. The first transistor T1, the third transistor T3, the fourth transistor T4, and the sixth transistor T6 are in the off state, and the fifth transistor T5 is in the on state. Further, for example, in this case, a potential held at the first node N1 is a potential Vb, a potential held at the second node N2 is a potential Vc, and a potential held at the third node N3 is a potential Va. The potential Vb is smaller than the potential Vc. The potential Vc is lower than the driving potential VDDEL. The potential difference Vgs (potential Vc−potential Va) is greater than the threshold voltage VTH, and the second transistor T2 is in the on state. Therefore, the second transistor T2 can cause the current Ion based on the potential difference Vgs corresponding to the potential VSIGH input during the horizontal period HRP of the K−1st FRAME and the potential difference Vds to flow from the driving potential line PVDD to the light-emitting element OLED and the reference potential line VSIGH. Consequently, the light-emitting element OLED emits light. For example, the pixel 180 (the pixel circuit 181) emits red light, and three pixels using the pixel 180 emitting red light, the pixel 180 emitting blue light, and the pixel 180 emitting green light emit white light. In addition, the potential held at the first node N1 is the potential Vb due to capacitive coupling by the capacitive element CV and the capacitive element CD.

In the period between the light emitting period PEM of the K−1st FRAME and the period PIN of the Kth FRAME following the light emitting period PEM of the K−1st FRAME, the potential of the data signal VDATA supplied to pixels other than the selected pixel 180 (pixel circuit 181) is supplied to the image data signal SL(m) (data signal VDATA). First, the fifth scan signal SC5(n) changes from the state where HI is supplied to the state where LO is supplied. If the fifth scan signal SC5(n) is supplied with LO, the first scan signal SC1(n) changes from the state where LO is supplied to the state where HI is supplied. The second scan signal SC2(n), the third scan signal SC3(n), and the fourth scan signal SC4(n) are in the state where LO is supplied.

In addition, in the period PIN of the Kth FRAME, the potential of the data signal VDATA supplied to the pixel 180 (pixel circuit 181) other than the selected pixel is supplied to the image data signal SL(m) (data signal VDATA). If the first scan signal SC1(n) is supplied with HI, the fourth scan signal SC4(n) changes from the state where LO is supplied to the state where HI is supplied. The fourth scan signal SC4(n) is maintained in the state in which HI is supplied, and then changes from the state in which HI is supplied to the state in which LO is supplied. If the fourth scan signal SC4(n) is supplied with LO, the second scan signal SC2(n) changes from the state where LO is supplied to the state where HI is supplied. The third scan signal SC3(n) and the fifth scan signal SC5(n) remain in the state where LO is supplied, and the first scan signal SC1(n) remains in the state where HI is supplied.

Consequently, from a period between the light emitting period PEM of the K−1st FRAME and the period PIN of the Kth FRAME to the period PIN of the Kth FRAME, the fifth transistor T5 is turned from the on state to the off state, and the current Ion does not flow from the driving potential line PVDD to the light-emitting element OLED and the standard potential line PVSS.

Further, the sixth transistor T6 is turned from the off state to the on state, the first node N1 is electrically connected to the reference potential line SVR, and the potential supplied to the first node N1 drops from the potential Vb toward the reference potential VREF (a potential Vd), and becomes the potential VREF (potential Vd). In this case, since the first transistor T1 and the third transistor T3 are in the off state and the second node N2 is in a floating state, the potential supplied to the first node N1 drops from the potential Vb to the potential Vd, and the potential supplied to the second node N2 drops from the potential Vc toward a potential Ve and becomes the potential Ve. In addition, a potential difference between the potential Vb and the potential Vd is substantially the same as a potential difference between the potential Vc and the potential Ve.

Further, the fourth transistor T4 is turned from the off state to the on state, the third node N3 is electrically connected to the initialization potential line SVI, and the initialization potential VINI (a potential Vf, −0.6 V) is supplied to the third node N3. For example, the light emission of the light-emitting element OLED is stopped because a threshold voltage VTHEL of the light-emitting element OLED is 0.7 V, and the third node N3 is supplied with the potential Vf that is smaller than the threshold voltage VTHEL. Even if the potential supplied to the third node N3 becomes the potential Vf, since the sixth transistor T6 remains in the on state, the potential supplied to the first node N1 remains at the potential Vd. Further, since the first transistor T1 and the third transistor T3 are maintained in the off state, the potential supplied to the second node N2 is maintained at the potential Ve. In this case, although the potential difference Vgs becomes a potential difference between the potential Ve and the potential Vf, since the potential difference between the potential Ve and the potential Vf is larger than the threshold voltage VTH, the second transistor T2 is in the on state. However, since the fifth scan-signal SC5(n) maintains the state in which LO is supplied and the fifth transistor T5 is in the off state, no drain current (current Ion) flows from the driving potential VDDEL to the second transistor T2.

In addition, if the fourth scan signal SC4(n) is supplied with LO, the fourth transistor T4 is turned from the on state to the off state, and the initialization potential line VINI and the third node N3 are shut off. Further, if the fourth scan signal SC4(n) is supplied with LO and the second scan signal SC2(n) is supplied with HI, the third transistor T3 is turned from the off state to the on state, the second node N2 is conducted to the reset potential line SVRE, and the potential supplied to the second node N2 drops from the potential Ve toward the reset potential VRES (a potential Vg, for example, 1.4 V) and becomes the potential Vg. In this case, the potential difference Vgs is a potential difference between the potential Vg and the potential Vf, since the potential difference (2 V) between the potential Vg (reset potential VRES, 1.4 V) and the potential Vf (−0.6 V) is larger than the threshold voltage VTH (1 V), so that the second transistor T2 is in the on state.

As described above, in the period PIN, the first node N1 is initialized by the reference potential VREF, the second node N2 is initialized by the reset potential VRES, and the third node N3 is initialized by the initialization potential VINI.

In the period PVH following the period PIN, the image data signal SL(m) (data signal VDATA) is supplied with the potential of the data signal VDATA supplied to pixels other than the selected pixel 180 (pixel circuit 181), the fifth scan signal SC5(n) changes from the state where LO is supplied to the state where HI is supplied, and the fifth transistor T5 is turned from the off state to the on state. The other scan signals and the other transistors are in the same condition as the period PIN.

Consequently, in the period PVH, the first node N1 maintains the potential Vd and the second node N2 maintains the potential Vg. Further, for example, at the beginning of the period PVH, the potential difference Vgs is 2 V, and the second transistor T2 is in the on state. Since the fifth transistor T5 and the second transistor T2 are in the on state, the fourth node N4 and the third node N3 are conducted, and the current Ion flows from the driving potential line PVDD to the fourth node N4 and the third node N3. Since the fourth transistor T4 is in the off state, the potential supplied to the third node N3 is released and gradually rises from the potential Vf. That is, the third node N3 is charged. When the potential difference Vgs (the potential difference between the potential supplied to the second node N2 and the potential supplied to the third node N3) becomes the threshold voltage VTH, the second transistor T2 is turned off. In this case, the first node N1 maintains the potential Vd, and the second node N2 maintains the potential Vg (reset potential VRES, 1.4 V). Therefore, for example, in the case where the threshold voltage VTH is 1 V (designed value), the potential supplied to the third node N3 is 0.4 V (1.4 V−1 V). In this case, with reference to the potential Vg (reset potential VRES, 1.4 V) supplied to the second node N2, the potential difference between the potential Vg supplied to the second node N2 (second electrode 54 of the capacitive element CD) and 0.4 V supplied to the third node N3 (first electrode 42 of the capacitive element CV) becomes the threshold voltage VTH (the potential at the third node N3=VRES−VTH). In practice, the threshold voltage VTH varies in manufacturing, the driving method of the display device 10 includes that the potentials supplied to the respective nodes become potentials corresponding to the threshold voltage VTH which varies in manufacturing by the operation in the period PVH. Therefore, the driving method of the display device 10 includes acquiring a threshold voltage VTH that varied in manufacturing, and applying corrections to the acquired threshold voltage VTH. As a result, in the driving method of the display device 10, the threshold voltage VTH can be corrected by operating the period PVH.

As described above, in the period PVH, by making the potential difference Vgs of the second transistor T2 equal to the threshold voltage VTH, the threshold voltage VTH of the second transistor T2 is acquired, and a charge equivalent to the threshold voltage VTH is held in the capacitance element CV.

In a period between the period PVH and the period PWR following the period PVH, the potential of the data signal VDATA supplied to pixels other than the selected pixel 180 (the pixel circuit 181) is supplied to the image data signal SL(m) (the data signal VDATA). First, the fifth scan signal SC5(n) changes from the state where HI is supplied to the state where LO is supplied. If the fifth scan signal SC5(n) is supplied with LO, the second scan signal SC2(n) changes from the state where HI is supplied to the state where LO is supplied. The first scan signal SC1(n) is supplied with HI, and the third scan signal SC3(n) and the fourth scan signal SC4(n) are supplied with LO. The fifth transistor T5 and the third transistor T3 are turned from the on state to the off state. The rest of the transistors are similar to the period PVH. The potential supplied to the first node N1 maintains the potential Vd, the potential supplied to the second node N2 maintains the potential Vg, the potential supplied to the third node N3 maintains the potential Vh, and the potential difference Vgs is the potential Vg−potential Vh (0.4 V). The second transistor T2 remains in the off state.

In the period PWR following the period between the period PVH and the period PWR, the image data signal SL(m) (the data signal VDATA) is supplied with the potential VSIGL (0.4 V). The third scan signal SC3(n) changes from the state where LO is supplied to the state where HI is supplied, and the first transistor T1 is turned from the off state to the on state. Other control signals and the transistors are the same as those of the period PVH. The potential supplied to the first node N1 maintains the potential Vd, and the potential supplied to the third node N3 maintains the potential Vh. Since the first transistor T1 is turned from the off state to the on state, the second node N2 is electrically connected to the image data signal line 321, and the potential supplied to the second node N2 gradually drops from the potential Vg toward the potential Vh (potential VSIGL, 0.4 V) and becomes the potential Vh. In this case, the capacitive element CD maintains the potential difference (−2.2 V based on the potential supplied to the first node N1) by holding a charge corresponding to the potential difference between Vd (reference potential VREF, 2.6 V) supplied to the first node N1 and the potential Vh (0.4 V) supplied to the second node N2. Further, the capacitive element CV maintains the potential difference (2.2 V based on the potential supplied to the third node N3) by holding charges corresponding to the potential difference between Vd (the reference potential VREF, 2.6 V) supplied to the first node N1 and the potential Vh (0.4 V) supplied to the third node N3. A sum (−2.2 V+2.2 V) of the potential difference held in the capacitive element CD and the potential difference held in the capacitive element CV is 0 V, that is, the potential difference Vgs is 0 V. Therefore, the second transistor T2 is in the off state.

As described above, in the period PWR, the data signal VDATA is written to the pixel 180 (the pixel circuit 181). The capacitive element CD maintains (holds) the data potential of the data signal VDATA.

During a period after the period PWR, the third scan signal SC3(n) changes from the state where HI is supplied to the state where LO is supplied. If the third scan signal SC3(n) is supplied with LO, the first scan signal SC1(n) changes from the state where HI is supplied to the state where LO is supplied. The first transistor T1 and the sixth transistor T6 are turned from the on state to the off state. Other scan signals and transistors are the same as the period PWR. The potential supplied to the first node N1 capacitively coupled by the capacitive element CV and the capacitive element CD maintains the potential Vd, and the potential supplied to the second node N2 and the potential supplied to the third node N3 maintain the potential Vh. That is, the potential difference Vgs is maintained at 0 V, and the second transistor T2 is in the off state.

In the light emitting period PEM of the Kth FRAME following the period PWR of the Kth FRAME, the potential of the data signal VDATA supplied to pixels other than the selected pixel 180 (pixel circuit 181) is supplied to the image data signal SL(m) (data signal VDATA). The fifth scan signal SC5(n) changes from the state where LO is supplied to the state where HI is supplied. Therefore, the fifth transistor T5 is turned from the off state to the on state. The other scan signals and the other transistors are in the same condition as the period after the period PWR of the Kth FRAME.

Consequently, the fifth transistor T5 is turned on, and the driving potential line PVDD is electrically connected to the fourth node N4. Since the second transistor T2 is in the off state, the current Ion does not flow, and the potential supplied to the third node N3 maintains the potential Vh. Further, the potential supplied to the first node N1 maintains the potential Vd by capacitive coupling of the capacitive element CV, and the potential supplied to the second node N2 maintains the potential Vh by capacitive coupling of the capacitive element CD and the capacitive element CV. The potential difference Vgs is a sum of the potential difference held in the capacitive element CD and the potential difference held in the capacitive element CV (potential of the data signal VDATA (potential VSIGL, 0.4 V)−reference potential VREF (2.6 V)+reference potential VREF (2.6 V)−(reset potential VRES (1.4 V)−threshold voltage VTH (1 V)=0 V). In the pixel 180 (the pixel circuit 181) in which the data signal VDATA includes the potential VSIGL, the potential difference Vgs is 0 V and the second transistor T2 is in the off state, so that the electrode Ion does not flow. Therefore, the light-emitting element OLED does not emit light. As a result, the pixel 180 (the pixel circuit 181) emitting red becomes black. In the same manner as the pixel 180 that emits red light, the pixel 180 that emits blue light and the pixel 180 that emits green light do not emit light, and therefore, the three pixels using the pixel 180 that emits red light, the pixel 180 that emits blue light, and the pixel 180 that emits green light become black.

As described above, the display device 10 does not include a transistor connected between the gate electrode 622 of the second transistor T2 and the second electrode 54 of the capacitive element CD, and has a configuration in which the gate electrode 622 of the second transistor T2 is connected to the second electrode 54 of the capacitive element CD. In addition, the display device 10 has a configuration in which the light-emitting element OLED is arranged between the third node N3 (the first electrode 624 of the second transistor T2) and the standard potential line PVSS. Further, the display device 10 includes the capacitive element CV and the capacitive element CD connected in series, and includes a configuration in which the first electrode 52 of the capacitive element CD and the second electrode 44 of the capacitive element CV are connected to the first node N1, and a configuration in which a potential difference corresponding to a charge according to a data potential is acquired and maintained in the capacitive element CD with the reference potential VREF as a reference, and a potential difference corresponding to a charge according to the threshold voltage VTH of the second transistor T2 is acquired and maintained in the capacitive element CV with the reference potential VREF as a reference. In addition, the display device 10 is capable of independently controlling each node. In addition, the method for driving the display device 10 includes executing the period PWR after the period PVH.

For example, in the method for driving the display device 10 and the display device 10 including the configuration described above, the information (data) of the threshold voltage VTH can be applied to a low potential side (the first electrode 42, the first electrode 624, and the third node N3 of the capacitive element CV) of the potential difference Vgs of the second transistor T2 with reference to the reference potential VREF, the potential (data) of the data signal VDATA can be applied to a high potential side (the second electrode 54, the gate electrode 622, and the second node N2 of the capacitive element CD) of the potential difference Vgs of the second transistor T2, and the variation of the potential (potential variation) supplied to the first node N1, the second node N2, and the third node N3 can be minimized from the period PWR to the light emitting period PEM.

Further, for example, the display device 10 including the configuration described above includes the pixel circuit 181 including the six transistors, and includes a configuration capable of suppressing the number of elements of the pixels. As a result, the display device 10 has a configuration that can reduce the number of elements to be formed, is expected to improve yield, and can have high-definition and a large screen.

### 1-5-2. Second Example of Driving Method of Display Device 10

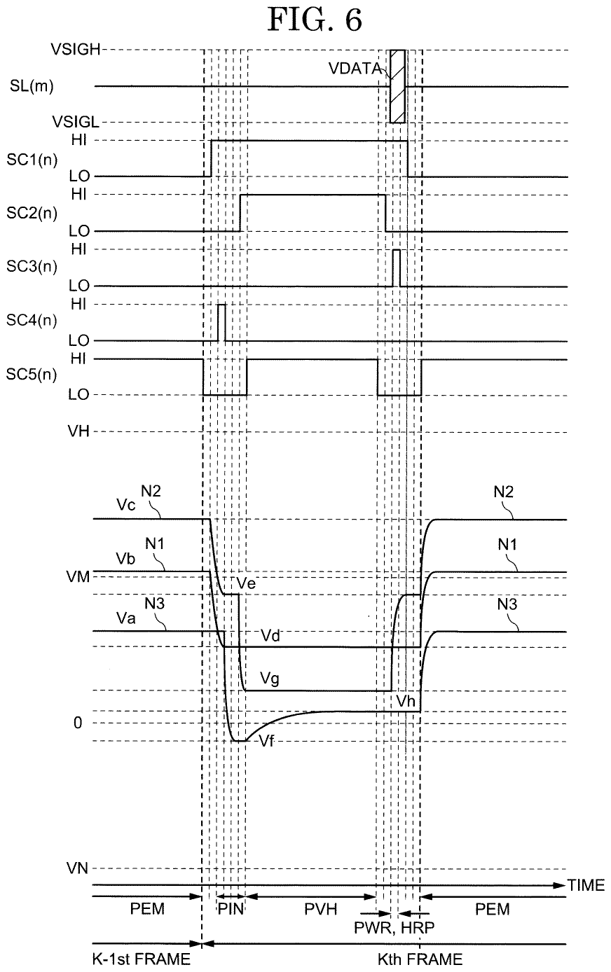

A second example of a driving method of the pixel circuit 181 will be described with reference to FIG. 6. The driving method shown in the second embodiment includes that the pixel 180 (the pixel circuit 181) displays a white image based on the potential VSIGH included in the data signal VDATA in a previous frame (K−1st FRAME) of the current frame (Kth FRAME), and then the pixel 180 (the pixel circuit 181) displays a white image based on the potential VSIGH included in the data signal VDATA in the Kth FRAME. In other words, the driving method shown in the second example includes displaying images of the same color (white) in consecutive frames. Configurations that are the same as or similar to those in FIG. 1 to FIG. 5 will be described as necessary.

The potential of the respective nodes in the light emitting period PEM of the K−1st FRAME to the period PVH of the Kth FRAME, and the period between the period PVH of the Kth FRAME and the period PWR of the Kth FRAME are the same as those described in the section “1-5-1. First Example of Driving Method of Display Device 10”. In addition, the configuration of each scan signal and the operation of each transistor in each period are the same as the configuration described in the section “1-5-1. First Example of Driving Method of Display Device 10”. Therefore, configurations and the like similar to those described in the section “1-5-1. First Example of a Driving Method of the Display Device 10” are described as necessary and may be omitted. In addition, the image data signal SL(m) is supplied in the period PWR of the Kth FRAME with the data signal VDATA including VSIGH (4 V) corresponding to the white color, and the same data signal VDATA as the configuration described in the section “1-5-1. First Example of Driving Method of Display Device 10” is supplied in the period other than the period PWR of the Kth FRAME.

In the light emitting period PEM of the K−1st FRAME, in the same manner as the configuration described in the section “1-5-1. First Example of Driving Method of Display Device 10”, the pixels 180 using three pixels using the pixel 180 emitting red light, the pixel 180 emitting blue light, and the pixel 180 emitting green light emit white light.

In the same manner as the configuration described in the section “1-5-1. First Example of Driving Method of Display Device 10”, from the period between the light emitting period PEM of the K−1st FRAME and the period PIN of the Kth FRAME to the period Kth FRAME, the first node N1 is initialized by the reference potential VREF, the second node N2 is initialized by the reset potential VRES, and the third node N3 is initialized by the initialization potential VINI.

In the period PVH following the period PIN, in the same manner as the configuration described in the section “1-5-1. First Example of Driving Method of Display Device 10”, the threshold voltage VTH of the second transistor T2 is acquired by the operation in which the potential difference Vgs of the second transistor T2 becomes the same as the threshold voltage VTH, and the charge corresponding to the threshold voltage VTH is held in the capacitive element CV. In addition, in practice, although the threshold voltage VTH varies in manufacturing, in the same manner as the configuration described in the section “1-5-1. First Example of Driving Method of Display Device 10”, the second example of the driving method of the display device 10 includes that a potential supplied to the respective nodes by the operation in the period PVH becomes a potential corresponding to the threshold voltage VTH that varies in manufacturing, and that the threshold voltage VTH that varies in manufacturing is obtained and correction is performed using the obtained threshold voltage VTH. Consequently, in the second example of the driving method of the display device 10, it is possible to correct the threshold voltage VTH by operating the period PVH in the same manner as in the configuration described in the section “1-5-1. First Example of Driving Method of Display Device 10”.

In a period between the period PVH and the period PWR following the period PVH, in the same manner as the configuration described in the section “1-5-1. First Example of Driving Method of Display Device 10”, the potential supplied to the first node N1 maintains the potential Vd, the potential supplied to the second node N2 maintains the potential Vg, the potential supplied to the third node N3 maintains the potential Vh, and the potential difference Vgs is the potential Vg−the potential Vh.

In the period PWR following the period between the period PVH and the period PWR following the period PVH, the image data signal SL(m) (data signal VDATA) is supplied with the potential VSIGH (potential Ve, for example, 4.4 V). The potential supplied to the first node N1 maintains the potential Vd, and the potential supplied to the third node N3 maintains the potential Vh (0.4 V). The potential supplied to the second node N2 gradually increases from the potential Vg (reset potential VRES, 1.4 V) toward the potential Ve, and becomes the potential Ve. In this case, the capacitive element CD maintains the potential difference (1.8 V based on the potential supplied to the second node N2) by holding charges corresponding to the potential difference (1.8 V based on the potential supplied to the second node N2) between the potential Vd (the reference potential VREF, 2.6 V) supplied to the first node N1 and the potential Ve (the potential VSIGH, 4.4 V) supplied to the second node N2. Further, the capacitive element CV maintains the potential difference (the potential Vd−potential Vh (2.2 V) with respect to the potential supplied to the third node N3) by holding a charge corresponding to the potential difference between the potential Vd supplied to the first node N1 and the potential Vh supplied to the third node N3. A sum (1.8 V+2.2 V) of the potential difference held in the capacitive element CD and the potential difference held in the capacitive element CV is 4 V, and the potential difference Vgs is 4 V.

As described above, in the period PWR, the data signal VDATA is written to the pixel 180 (the pixel circuit 181). In addition, the capacitive element CD maintains (holds) the data potential of the data signal VDATA.

In the period after the period PWR, the potential supplied to the first node N1 capacitively coupled by the capacitive element CV and the capacitive element CD maintains the potential Vd, the potential supplied to the second node N2 maintains the potential Ve, and the potential supplied to the third node N3 maintains the potential Vh. That is, the potential difference Vgs is maintained at 4 V, and the second transistor T2 is in the on state.

In the light emitting period PEM of the Kth FRAME following the period PWR of the Kth FRAME, the potential difference Vgs is maintained at 4 V and the second transistor T2 is in the on state, so that the potential supplied to the third node N3 rises from the potential Vh toward the potential Vd and becomes the potential Vd. The sixth transistor T6 is in the off state and the first node N1 is in the floating state. In addition, the first transistor T1 and the third transistor T3 are in an off state, and the second node N2 is in the floating state. Therefore, since the potential supplied to the third node N3 is raised from the potential Vh to the potential Vd, the capacitive coupling by the capacitive element CV between the third node N3 and the first node N1 causes the potential supplied to the first node N1 to rise from the potential Vd to the potential Vb, and the capacitive coupling by the capacitive element CD between the first node N1 and the second node N2 causes the potential supplied to the second node N2 to rise from the potential Ve to the potential Vc. Consequently, the potential difference Vgs is the sum of the potential difference held in the capacitive element CD and the potential difference held in the capacitive element CV (the potential of the data signal VDATA (potential VSIGH, 4.4 V)−reference potential VREF (2.6 V)+reference potential VREF (2.6 V)−(reset potential VRES (1.4 V)−threshold voltage VTH (1 V)=4 V). In the case where the data signal VDATA includes the potential VSIGH, the potential difference Vgs is 4 V, and the second transistor T2 is in the on state, so that the light-emitting element OLED emits light by causing the driving potential line PVDD to flow through the light-emitting element OLED and the standard potential line PVSS with the current Ion. For example, the pixel 180 that emits red light, the pixel 180 that emits blue light, and the pixel 180 that emit green light emit light, respectively, and three pixels using the pixel 180 that emits red light, the pixel 180 that emits blue light, and the pixel 180 that emits green light become white. In other words, the pixel 180 (pixel circuit 181) can display images based on the data signal VDATA and the corrected threshold voltage.

The second example of the driving methods of the display device 10 has the same effects as those described in the section “1-5-1. First Example of Driving Method of Display Device 10”.

### 1-5-3. Third Example of Driving Method of Display Device 10

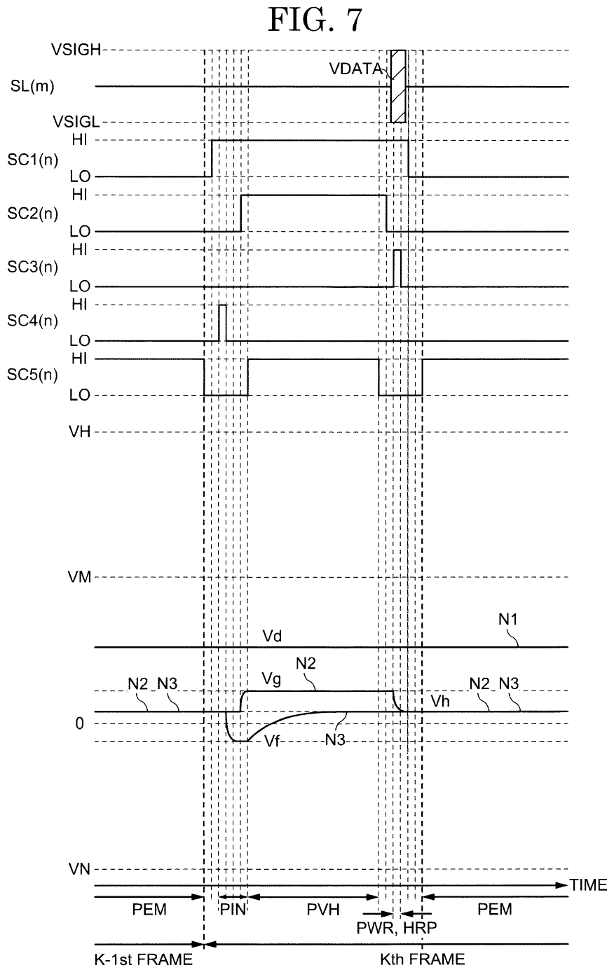

A third example of the driving method of the display device 10 will be described with reference to FIG. 7. The driving method shown in the third example includes that the pixel 180 (pixel circuit 181) displays a black image based on the potential VSIGL included in the data signal VDATA in the previous frame (K−1st FRAME) of the current frame (Kth FRAME), and then the pixel 180 (pixel circuit 181) displays a black image based on the potential VSIGL included in the data signal VDATA in the Kth FRAME. In other words, the driving method shown in the third example includes displaying images of the same color (black) in consecutive frames. Configurations that are the same as or in the same manner as those in FIG. 1 to FIG. 6 will be described as necessary. Configurations that are the same as or similar to those in FIG. 1 to FIG. 6 will be described as necessary.

The potentials and the like of the respective nodes in the period PVH of the Kth FRAME to the light emitting period PEM of the Kth FRAME are the same as those described in the section “1-5-1. First Example of Driving Method of Display Device 10”. The configuration of each scan signal and the operation of each transistor in each period are the same as the configuration described in the section “1-5-1. First Example of Driving Method of Display Device 10”. Therefore, configurations and the like similar to those described in the section “1-5-1. First Example of Driving Method of Display Device 10” will be described as necessary.

In the light emitting period PEM of the K−1st FRAME, for example, the potential held at the first node N1 is the potential Vd (reference potential VREF, 2.6 V). Further, the potential supplied to the second node N2 and the potential held at the third node N3 are the potential Vh (0.4 V), and the potential difference Vgs is 0 V. Therefore, the second transistor T2 is in the off state, the current Ion does not flow, and the light-emitting element OLED does not emit light.

As a result, the pixel 180 that emits red (the pixel circuit 181), the pixel 180 that emits blue, and the pixel 180 that emits green do not emit light, and three pixels using the pixel 180 that emits red, the pixel 180 that emits blue, and the pixel 180 that emits green become black.

From a period between the light emitting period PEM of the K−1st FRAME and the period PIN of the K−1st FRAME following the light emitting period PEM of the K−1st FRAME, in the same manner as the configurations described in the section “1-5-1. First Example of Driving Method of Display Device”, the potential supplied to the first node N1 maintains the potential Vd and the potential supplied to the third node N3 becomes the initialization potential VINI (the potential Vf, −0.6 V). While the third transistor T3 remains in the off state, the potential supplied to the second node N2 maintains the potential Vh. In the case where the fourth scan signal SC4 changes from the state where HI is supplied to the state where LO is supplied, and the second scan signal SC2 changes from the state where LO is supplied to the state where HI is supplied, the third transistor T3 is turned from the off state to the on state, the second node N2 is electrically connected to the reset potential line SVRE, and the potential supplied to the second node N2 gradually rises from the potential Vh toward the potential Vg (reset potential VRES), and becomes the potential Vg. Therefore, the potential difference Vgs is the potential Vg−potential Vf (1.4 V−(−0.6 V)=2 V), and the second transistor T2 is in the on state.

As described above, in the same manner as in the configuration described in the section “1-5-1. First Example of Driving Method of Display Device 10”, in the period PIN, the first node N1 is initialized by the reference potential VREF, the second node N2 is initialized by the reset potential VRES, and the third node N3 (the fifth node N5) is initialized by the initialization potential VINI.

In the period PVH following the period PIN, in the same manner as the configuration described in the section “1-5-1. First Example of Driving Method of Display Device 10”, the threshold voltage VTH of the second transistor T2 is acquired by the operation in which the potential difference Vgs of the second transistor T2 becomes the same as the threshold voltage VTH, and the charge corresponding to the threshold voltage VTH is held in the capacitive element CV. In addition, in practice, although the threshold voltage VTH varies in manufacturing, in the same manner as the configuration described in the section “1-5-1. First Example of Driving Method of Display Device 10”, the third example of the driving method of the display device 10 includes that the potential supplied to the respective nodes by the operation in the period PVH becomes a potential corresponding to the threshold voltage VTH that varies in manufacturing, and that the threshold voltage VTH that varies in manufacturing is obtained and correction is performed using the obtained threshold voltage VTH. Consequently, in the third example of the driving method of the display device 10, it is possible to correct the threshold voltage VTH by operating the period PVH in the same manner as in the configuration described in the section “1-5-1. First Example of Driving Method of Display Device 10”.

In the period PWR following the period PVH, the data signal VDATA is written to the pixel 180 (the pixel circuit 181) in the same manner as in the configuration described in the section “1-5-1. First Example of Driving Method of Display Device 10”. The capacitive element CD maintains (holds) the data potential of the data signal VDATA.

In the period after the period PWR and the light emitting period PEM of the Kth FRAME following the period after the period PWR, the pixel circuit 181 operates in the same manner as the configuration described in the section “1-5-1. First Example of Driving Method of Display Device 10”, and since the potential difference Vgs is 0 V and the second transistor T2 is in the off state, the current Ion does not flow and the light-emitting element OLED does not emit light. As a result, the pixels 180 become black by the three pixels using the pixel 180 that emits red, the pixel 180 that emits blue, and the pixel 180 that emits green.

The third example of the driving method of the display device 10 has the same effects as those described in the section “1-5-1. First Example of Driving Method of Display Device 10”.

### 1-5-4. Fourth Example of Driving Method of Display Device 10

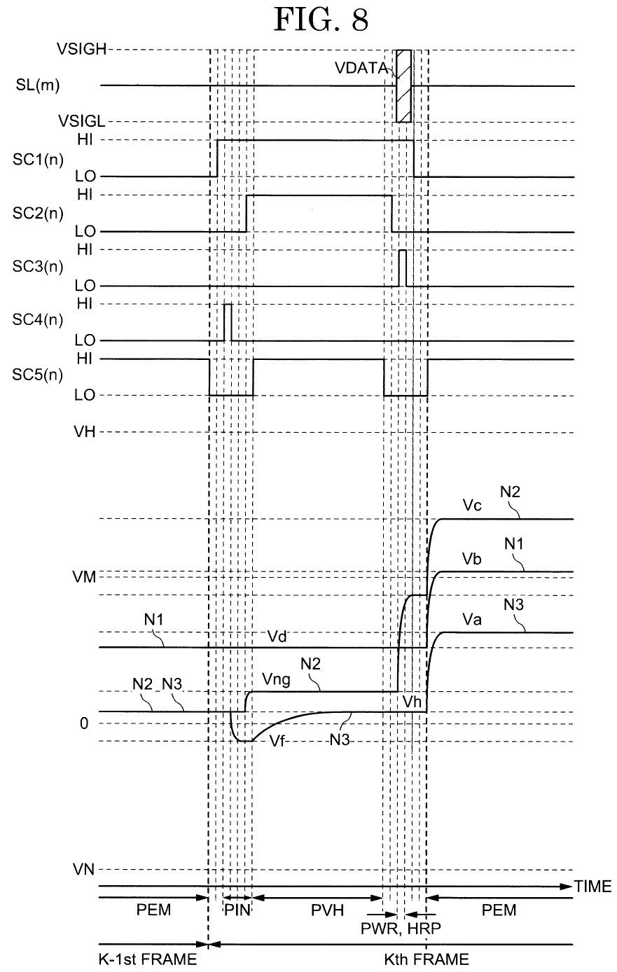

A fourth example of the driving method of the display device 10 will be described with reference to FIG. 8. The driving method shown in the fourth example includes that the pixel 180 (pixel circuit 181) displays a black image based on the potential VSIGL of the data signal VDATA in the previous frame (K−1st FRAME) of the current frame (Kth FRAME), and then the pixel 180 (pixel circuit 181) displays the white image based on the potential VSIGH of the data signal VDATA in the Kth FRAME. In other words, the driving method shown in the fourth example includes displaying images of different colors in successive frames. Configurations that are the same as or similar to those in FIG. 1 to FIG. 7 will be described as necessary.

The potential of each node, the configuration of each scan signal, the operation of each transistor, and the like in the light emitting period PEM of the K−1st FRAME to the period PVH of the Kth FRAME are the same as those described in the section “1-5-3. Third Example of Method for Driving Display Device 10”. Further, the potential of each node, the configuration of each scan signal, the operation of each transistor, and the like from a period after the period PVH of the Kth FRAME to the light emitting period PEM of the Kth FRAME are the same as those described in the section “1-5-2. Second Example of Method for Driving Display Device 10”. Therefore, the description thereof will be omitted.

The fourth example of the driving method of the display device 10 has the same effects as those described in the section “1-5-1. First Example of Driving Method of Display Device 10”.

### 1-6. End Face Structure of Pixel 180

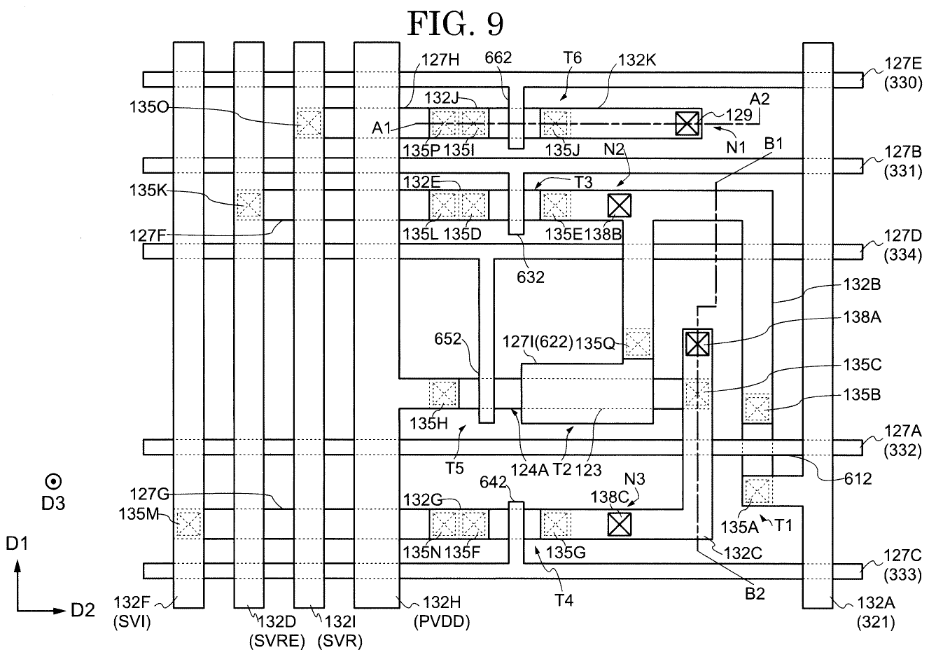

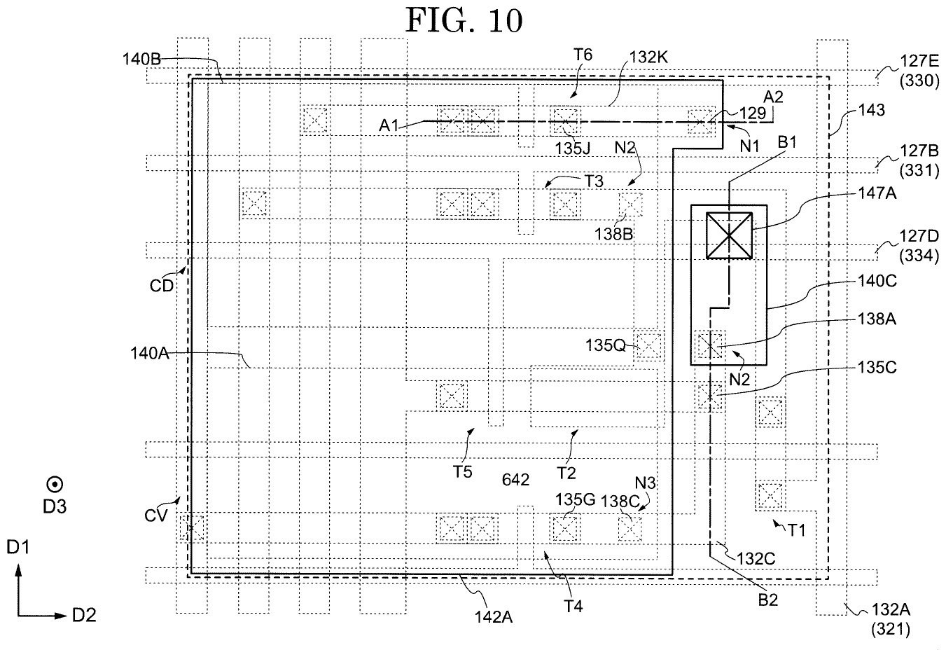

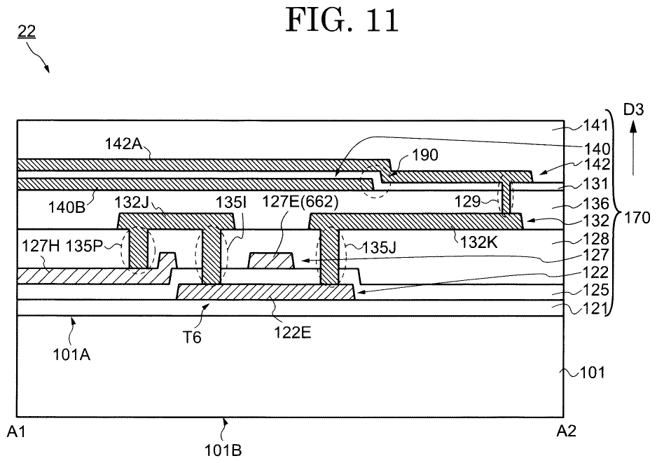

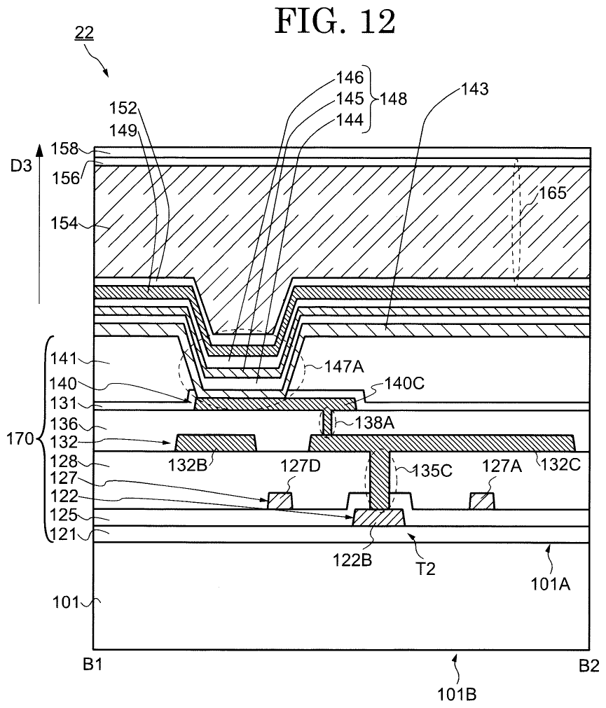

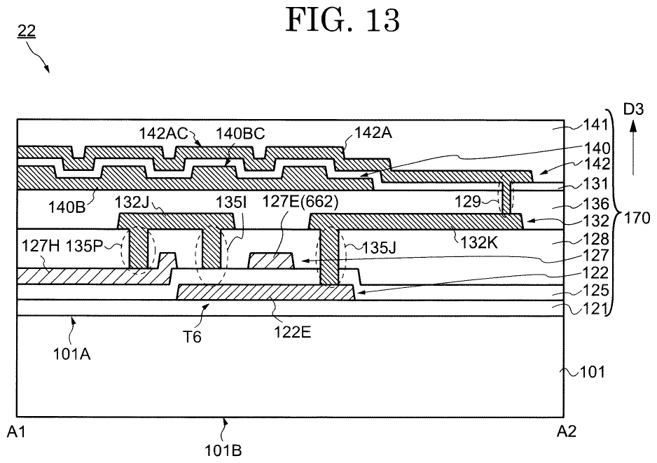

An end face structure of the pixel 180 will be described with reference to FIG. 9 to FIG. 17. FIG. 9 and FIG. 10 are layout diagrams of the pixels 180 when the display device 10 is viewed from a front side (a first surface 101A). FIG. 11 is an end view showing an end face cut along A1-A2 in the layout shown in FIG. 9. FIG. 12 is an end view showing an end face cut along B1-B2 in the layout shown in FIG. 9. FIG. 13 is an end view showing a modification of the end face cut along A1-A2 in the layout shown in FIG. 9. The layout of the pixels 180 shown in FIG. 9 and FIG. 10 and the end faces of the pixels 180 shown in FIG. 11 to FIG. 13 are examples, and the layout and the end faces of the pixels 180 are not limited to the examples shown in FIG. 9 to FIG. 13. Configurations that are the same as or similar to those in FIG. 1 to FIG. 8 will be described as necessary.

In addition, in the layout of the pixel 180 shown in FIG. 9, for the sake of clarity, a semiconductor layer 122, a conductive layer 127, a conductive layer 132, a first contact hole opening 135, a second contact hole opening 138, and a third contact hole opening 129 are omitted. Further, in the layout of the pixel 180 shown in FIG. 10, for the sake of clarity of the drawing, each element shown in FIG. 9, a portion of a conductive layer 140, and an anode 143 are shown by broken lines, a portion of the conductive layer 140, a conductive layer 142, and a contact hole opening 147 for the anode are shown by solid lines, and the reference signs of the other elements and the respective elements are omitted. In addition, in the end face of the pixel 180 shown in FIG. 11 and FIG. 13, the configuration of the upper layer over the insulating layer 141 is omitted along the third direction D3.

Further, the end face of the pixel 180 shown in FIG. 11 is an end face along a second electrode 142A, a first electrode 140B, a gate line 127H, a first line 132J, first contact hole openings 135P and 1351, a semiconductor layer 122E, a gate line 127E, a first wiring 132K, a first contact hole opening 135J, and the third contact hole opening 129 as an example of the end face of the pixel 180. The end face of the pixel 180 shown in FIG. 12 is an end face along the anode 143, a functional layer 148, a cathode 149, a first wiring 132B, a first electrode 140C, a contact hole opening 147A for the anode, a gate wiring 127D, a first wiring 132C, a semiconductor layer 122B, a first contact hole opening 135C, and a gate wiring 127A, as an example of the end face of the pixel 180. The end face of the pixel 180 shown in FIG. 13 is an end face along the second electrode 142A, the first electrode 140B, the gate wiring 127H, the first wiring 132J, the first contact hole openings 135P and 1351, the semiconductor layer 122E, the gate wiring 127E, the first wiring 132K, the first contact hole opening 135J, and the third contact hole opening 129, as an example of the end face of the pixel 180.

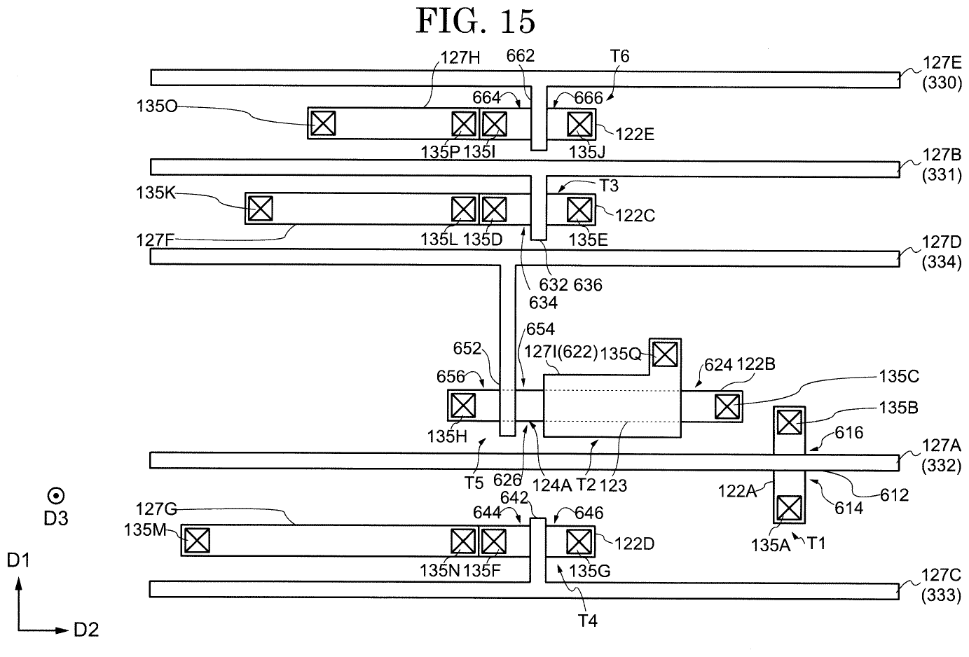

A substrate 101 includes the first surface 101A and a second surface 101B opposed to the first surface 101A. The semiconducting layer 122 is provided on the first surface 101A of a base plate 101 via a base layer 121. The semiconductor layer 122 includes the semiconductor layer 122E and the semiconductor layer 122B. The semiconductor layer 122B includes a channel region 123 and an impurity region 124A. For example, the impurity region is referred to as a source region or a drain region. Further, for example, the second transistor T2 and the fifth transistor T5 include the semiconductor layer 122B, and the first electrode 624 (see FIG. 15) and the second electrode 626 (see FIG. 15) and the first electrode 654 (see FIG. 15) and the second electrode 656 (see FIG. 15) include the impurity regions 124A. In other words, the semiconductor layer 122B also serves as the channel region and the impurity region of the second transistor T2 and the fifth transistor T5. The sixth transistor T6 includes the semiconductor layer 122E, and the first electrode 664 (see FIG. 15) and the second electrode 666 (see FIG. 15) include the impurity region 124A. In other words, the semiconductor layer 122E includes the channel region of the sixth transistor T6.

In the same manner as the semiconductor layer 122B, the first transistor T1 includes the semiconductor layer 122A (see FIG. 15), the third transistor T3 includes a semiconductor layer 122C (see FIG. 15), and the fourth transistor T4 includes a semiconductor layer 122D. Further, the first electrode and the second electrode of each transistor include the impurity region. That is, the first electrode 614 (see FIG. 15) and the second electrode 616 (see FIG. 15) of the first transistor T1, the first electrode 634 (see FIG. 15) and the second electrode 636 (see FIG. 15) of the third transistor T3, and the first electrode 644 (see FIG. 15) and the second electrode 646 (see FIG. 15) of the fourth transistor T4 include impurity regions. In other words, the semiconductor layer 122A includes the channel region of the first transistor T1, the semiconductor layer 122C includes the channel region of the third transistor T3, and the semiconductor layer 122D includes the channel region of the fourth transistor T4.

On the semiconductor layer 122, a gate insulating layer 125, the conductive layer 127, an insulating layer 128, and the conductive layer 132 are provided in this order. The conductive layer 127 includes the gate wiring 127H, the gate wiring 127E (gate electrode 662), the gate wiring 127D (scan signal line 334), and the gate wiring 127A (scan signal line 332). The conductive layer 132 includes the first wiring 132J, the first wiring 132K, the first wiring 132B, and the first wiring 132C. In addition, a region where the conductive layer 127 and the semiconductor layer 122 overlap each other is a channel region. In other words, a region where the gate electrode and the semiconductor layer of each transistor overlap each other is a channel region.

Each of the transistors of the pixel 180 is formed using the semiconductor layer 122 (for example, the semiconductor layer 122B, the channel region 123, and the impurity region 124A), the gate insulating layer 125, and the conductive layer 127 (for example, the gate wiring 127A).

The first contact hole openings 1351 and 135J that reach the semiconductor layer 122 pass through the gate insulating layer 125 and the insulating layer 128, and are provided in the gate insulating layer 125 and the insulating layer 128. For example, the first contact hole openings 1351 and 135J expose the semiconductor layer 122E (for example, the second electrode 666 and the first electrode 664), the first wiring 132J is electrically connected to the semiconductor layer 122D by the first contact hole opening 1351, and the first wiring 132K is electrically connected to the semiconductor layer 122D by the first contact hole opening 135J. Further, the first contact hole opening 135C exposes the semiconductor layer 122B (for example, the first electrode 624), and the first wiring 132C is electrically connected to the semiconductor layer 122B by the first contact hole opening 135C. Further, the first wiring 132J is electrically connected to the gate wiring 127H by the first contact hole opening 135P. That is, the first contact hole opening may penetrate through the gate insulating layer 125 and the insulating layer 128 and may expose the semiconductor layer 122, and the first contact hole opening may penetrate through the insulating layer 128 and may expose the conductive layer 127.

An insulating layer 136 is provided to cover the conductive layer 132 and the insulating layer 128 where the conductive layer 132 is not exposed. The insulating layer 136 is provided to cover an insulating layer 131.

A second contact hole opening is provided in the insulating layer 138. For example, the second contact hole opening includes a second contact hole opening 138A. The conductive layer 140 is provided on the insulating layer 136 and on the second contact hole opening 138A. The conductive layer 140 includes the first electrode 140C (second electrode 34) and the first electrode 140B (second electrode 54). The second contact hole opening 138A penetrates the insulating layer 136 and exposes the first wiring 132C. The first electrode 140C is electrically connected to the first wiring 132C via the second contact hole opening 138A. For example, the first electrode 140C also serves as a pixel electrode. Further, although not shown, for example, the second contact hole opening 138 exposes a part of a plurality of terminals (not shown) included in the terminal portion 150. Part of the exposed terminals are electrically connected to the FPC 200 using a conductive film such as an anisotropic conductive film (not shown). Further, the pixel electrodes are provided independently for each pixel.

The insulating layer 131 is provided on the insulating layer 136 where the conductive layer 140 is not provided, and is provided so as to cover the conductive layer 140. The third contact hole opening 129 is provided in the insulating layers 131 and 136. The conductive layer 142 is provided on the insulating layer 131 and in the third contact hole opening 129. The conductive layer 142 includes the second electrode 142A (the first electrode 52 and a second electrode 44). The third contact hole opening 129 penetrates the insulating layers 131 and 136 and exposes the first wiring 132K. The second electrode 142A is electrically connected to the first wiring 132K through the third contact hole opening 129. For example, the capacitive element CV is formed using the insulating layer 131 as a dielectric and using the first electrode 140B (the first electrode 42) and the second electrode 142A (the second electrode 44), and the capacitive element CD is formed using the first electrode 140B (the second electrode 54) and the second electrode 142A (the first electrode 52) using the insulating layer 131 as a dielectric.

The insulating layer 141 is provided on the insulating layer 131 where the conductive layer 142 is not provided, and is provided so as to cover the conductive layer 142.

For example, the base layer 121, the semiconductor layer 122, the gate insulating layer 125, the conductive layer 127, the insulating layer 128, the conductive layer 132, the insulating layer 136, the conductive layer 140, the insulating layer 131, the conductive layer 142, and the insulating layer 141 are collectively referred to as an array portion 170.

Next, a plurality of layers stacked on the insulating layer 141 will be described. The contact hole opening 147 for the anode is provided in the insulating layer 141. The contact hole opening 147 for the anode includes a contact hole opening 147A for the anode. The contact hole opening 147A for the anode penetrates through insulating layers 141 and 131 and is provided in the insulating layers 141 and 131 to expose the conductive layer 140 (for example, the first electrode 140C).

The anode 143 is provided to cover the exposed first electrode 140C, the contact hole opening 147A for the anode, and the insulating layers 141 and 131. The functional layer 148 is provided on the anode 143. The cathode 149 (first electrode 32 of the light-emitting element OLED) is provided on the functional layer 148 so as to cover the functional layer 148. The cathode 149 is electrically connected to the standard potential line PVSS. Here, the light-emitting element OLED includes the anode 143, the functional layer 148, and the cathode 149.

A configuration of the functional layer 148 can be selected as appropriate. For example, the functional layer 148 may be formed by combining a carrier injection layer, a carrier transport layer, a light emitting layer, a carrier blocking layer, an exciton blocking layer, and the like. For example, the functional layer 148 shown in FIG. 12 includes a first layer 144, a second layer 145, and a third layer 146. For example, the first layer 144 is a carrier (hole) injection and transport layer, the second layer 145 is a light emitting layer, and the third layer 146 is a carrier (electron) injection and transport layer. For example, the functional layer 148 is provided independently for each pixel, similar to the pixel electrode.

A sealing film 165 is provided on the cathode 149. For example, the sealing film 165 includes a first inorganic insulating layer 152, an organic insulating layer 154, and a second inorganic insulating layer 156. The first inorganic insulating layer 152 and the second inorganic insulating layer 156 are formed so as to cover at least the display area 22. A cover film 158 is arranged over the second inorganic insulating layer 156.

For example, the first layer 144, the second layer 145 (light emitting layer) and the third layer 146, and the anode 143 included in the functional layer 148 are not arranged on the IC chip 110 and the control circuit 120. Above the IC chip 110 and the control circuit 120, the sealing film 165 and the cover film 158 are arranged. The sealing film 165 and the cover film 158 prevent impurities (water, oxygen, and the like) from entering the light-emitting element OLED and the transistors from outside of the display device 10.

For example, as shown in FIG. 13, the first electrode 140B may include a plurality of convex portions 140BC protruding from the insulating layer 136 toward the insulating layer 131 along the third direction D3, and the second electrode 142A may include a plurality of convex portions 142AC protruding from the insulating layer 131 toward the insulating layer 141 along the plurality of convex portions 140BC.

Since the capacitive element CD includes the plurality of convex portions 140BC and the plurality of convex portions 142AC, the surface area of the first electrode 140B and the second electrode 142A is increased, and thus the capacitance formed with the insulating layer 131 interposed therebetween can be increased. The capacitance of the capacitive element CV can be increased by sandwiching the insulating layers 131 in the same manner as the capacitive element CD. By using a high-dielectric material (high-k material) having a higher dielectric constant for the insulating layers 131, the capacitance of the capacitive elements CV and CD can be further increased. As a result, it is possible to suppress a decrease in the holding voltage or a loss in the holding voltage.

### 1-7. Method for Manufacturing Display Device 10

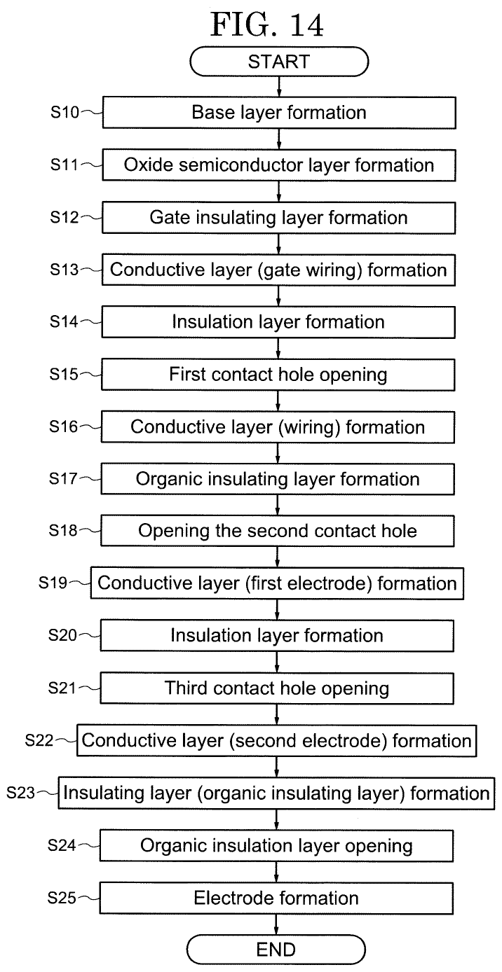

A method for manufacturing the display device 10 (pixel 180) will be described with reference to FIG. 9, FIG. 10, and FIG. 14 to FIG. 17. FIG. 14 is a sequence diagram showing a method for manufacturing the display device 10. FIG. 15 to FIG. 17 are diagrams showing the pixels 180 when the display device 10 is viewed from the front side (the first surface 101A). Configurations that are the same as or similar to those in FIG. 1 to FIG. 13 will be described as necessary, and description of the same or similar configurations as those in FIG. 1 to FIG. 13 may be omitted. The method for manufacturing the display device 10 includes, for example, that the semiconductor layer is an oxide semiconductor layer formed using an oxide semiconductor.

When manufacturing of the display device 10 (pixel 180) is started, the base layer 121 (see FIG. 11 to FIG. 13) is formed on the first surface 101A (see FIG. 11 to FIG. 13) of the substrate 101 (see FIG. 11 to FIG. 13) (step 10 (S10 in FIG. 14). For example, the substrate 101 is a glass substrate.

As shown in FIG. 15, the semiconductor layer 122 includes the semiconductor layers 122A, 122B, 122C, 122D, and 122E. The semiconductor layer 122A is a semiconductor layer of the first transistor T1. The semiconductor layer 122B serves as a semiconductor layer of the second transistor T2 and a semiconductor layer of the fifth transistor T5. The semiconductor layer 122C is a semiconductor layer of the third transistor T3. The semiconductor layer 122D is a semiconductor layer of the fourth transistor T4. The semiconductor layer 122E is a semiconductor layer of the sixth transistor T6. In other words, the semiconductor layer 122A includes the channel region of the first transistor T1, the semiconductor layer 122B includes the channel region of the second transistor T2 and the channel region of the fifth transistor T5, the semiconductor layer 122C includes the channel region of the third transistor T3, the semiconductor layer 122D includes the channel region of the fourth transistor T4, and the semiconductor layer 122E includes the channel region of the sixth transistor T6.

The gate insulating layer 125 (see FIG. 11 to FIG. 13) is formed on the semiconductor layer 122 and on the underlying layer 121 on which the semiconductor layer 122 is not formed (step 12 (S12) in FIG. 14).

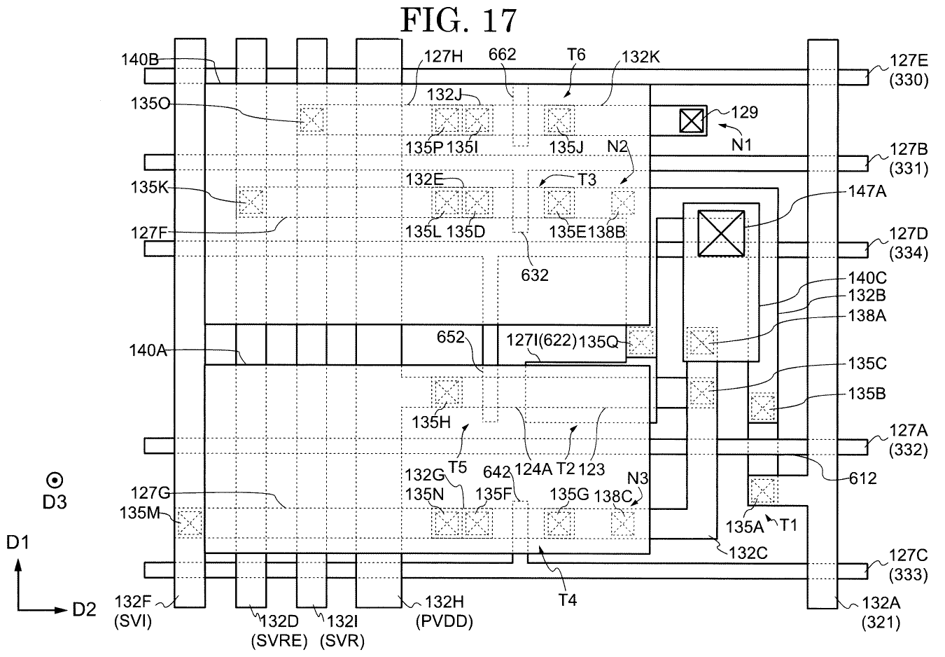

The conductive layer 127 (see FIG. 11 to FIG. 13) is formed over the gate insulating layer 125 (see FIG. 11 to FIG. 13) (step 13 (S13) in FIG. 14). As shown in FIG. 9, FIG. 15, and FIG. 17, the conductive layer 127 includes the gate wiring 127A (scan signal line 332), a gate wiring 127B (scan signal line 331), a gate wiring 127C (scan signal line 333), the gate wiring 127D (scan signal line 334), the gate wiring 127E (scan signal line 330), a gate wiring 127F, a gate wiring 127G, the gate wiring 127H, and a gate wiring 127I (gate electrode 622). The gate wiring 127A includes the gate electrode 612, the gate wiring 127B includes the gate electrode 632, the gate wiring 127C includes the gate electrode 642, the gate wiring 127D includes the gate electrode 652, and the gate wiring 127E includes the gate electrode 662.

The region where the gate electrode 622 of the second transistor T2 and the semiconductor layer 122B overlap each other is the channel region 123, and the channel region 123 corresponds to a channel length of the second transistor T2. In the same manner as the second transistor T2, a region where the gate electrode 612 of the first transistor T1 and the semiconductor layer 122A overlap each other is the channel region of the first transistor T1 and corresponds to a channel length. In the same manner as the second transistor T2 and the first transistor T1, the transistor other than the second transistor T2 and the first transistor T1 has a region in which the gate electrode and the semiconductor layer overlap each other, which is the channel region of the transistor and corresponds to a channel length.

As shown in FIG. 15, in a plan view, the channel region 123 of the second transistor T2 is larger (longer) than the channel region of the first transistor T1, the channel region of the third transistor T3, the channel region of the fourth transistor T4, the channel region of the fifth transistor T5, and the channel region of the sixth transistor T6. That is, the channel length of the second transistor T2 is longer than the channel length of the first transistor T1, the channel length of the third transistor T3, the channel length of the fourth transistor T4, the channel length of the fifth transistor T5, and the channel length of the sixth transistor T6. Since the second transistor T2 operates in a saturated range, a kink effect needs to be suppressed. Furthermore, the resistance of the second transistor T2 to hot carriers is preferably higher than the resistance of other transistors in the pixel 180 to hot carriers. The channel length of the second transistor T2 is longer than the channel lengths of the other transistors in the pixel 180 in order to suppress the kink effect and ensure reliability (hot carrier resistance).

The insulating layer 128 (see FIG. 11 to FIG. 13) is formed over a conductive layer 126 and over the gate insulating layer 125 where the conductive layer 126 is not formed (step 14 (S14) in FIG. 14).

As shown in FIG. 9, FIG. 15, and FIG. 17, first contact hole openings 135A to 135Q are opened (step 15 (S15) in FIG. 14). Each opening may open the gate insulating layer 125 and the insulating layer 128 to expose the semiconductor layer, and each opening may open the insulating layer 128 to expose the gate wiring. For example, the first contact hole opening 135A exposes the semiconductor layer 122A, and the first contact hole opening 135Q exposes the gate line 127I. Other openings also expose corresponding semiconductor layers or gate lines.

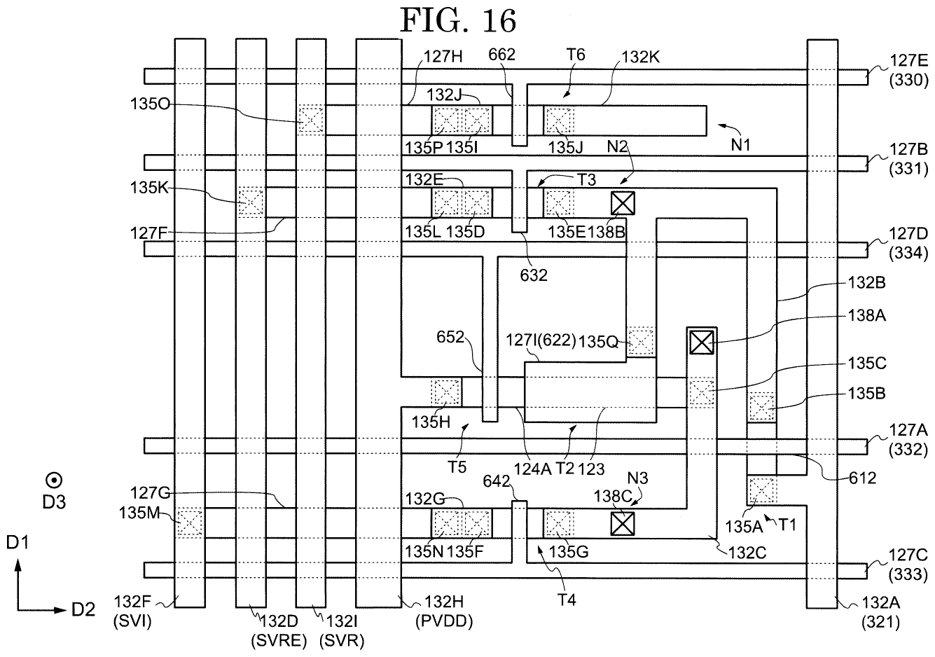

The conductive layer 132 (see FIG. 11 to FIG. 13) is formed over the insulating layer 128 or in the first contact hole opening 135 (step 16 (S16) in FIG. 14). As shown in FIG. 9, FIG. 16 and FIG. 17, the conductive layer 132 is a first wiring 132A (image data line 321), the first wiring 132B, the first wiring 132C, a first wiring 132D (reset potential line SVRE), a first wiring 132E, a first wiring 132F (initialized potential line SVI), a first wiring 132G, a first wiring 132H (drive potential line PVDD), a first wiring 132I (reference potential line SVR), including the first wiring 132J and the first wiring 132K.

As shown in FIG. 16, in a plan view, for example, the first wiring 132A is electrically connected to the first transistor T1 via the first contact hole opening 135A. Further, the first wiring 132B is electrically connected to the first transistor T1 via the first contact hole opening 135B, and is electrically connected to the gate wiring 127I (the gate electrode 622) via the first contact hole opening 135Q. The first wiring 132C is electrically connected to the fourth transistor T4 via the first contact hole opening 135G, and is electrically connected to the second transistor T2 via the first contact hole opening 135C. The other first wirings are also electrically connected to a gate wiring or a transistor (the semiconductor layer 122) through the corresponding opening.

The insulating layer 136 (see FIG. 11 to FIG. 13) is formed over the conductive layer 132 and over the insulating layer 128 where the conductive layer 132 is not formed (step 17 (S17) in FIG. 14).

As shown in FIG. 9, FIG. 16, and FIG. 17, the second contact hole opening 138 is opened (step 18 (S18) in FIG. 14). The second contact hole opening 138 includes second contact hole openings 138A to 138C. For example, the second contact hole opening 138A exposes the first wiring 132C. Each opening opens the insulating layer 136 to expose the first wiring corresponding to each opening.

The conductive layer 140 (see FIG. 11 to FIG. 13) is formed over the insulating layer 136 (see FIG. 11 to FIG. 13) and in the second contact hole opening 138 (step 19 (S19) of FIG. 14). As shown in FIG. 10 and FIG. 17, the conductive layer 140 includes first electrodes 140A (first electrode 42), 140B (second electrode 54), and 140C (second electrode 34).

As shown in FIG. 10 or FIG. 17, in a plan view, for example, the first electrode 140A is electrically connected to the first wiring 132C via the second contact hole opening 138C and is electrically connected to the fourth transistor T4 via the first contact hole opening 135G. Further, for example, the first electrode 140C is electrically connected to the first wiring 132C via the second contact hole opening 138A, is electrically connected to the second transistor T2 via the second contact hole opening 138C, is electrically connected to the fourth transistor T4 via the first contact hole opening 135G, and is electrically connected to the first electrode 140A via the second contact hole opening 138C. In the same manner as the first electrodes 140A and 140C, the first electrode 140B is electrically connected to the corresponding first wiring and is electrically connected to the corresponding gate wiring and transistor.

The insulating layer 131 (see FIG. 11 to FIG. 13) is formed over the conductive layer 140 and over the insulating layer 136 where the conductive layer 140 is not provided (step 20 (S20) in FIG. 14).

As shown in FIG. 9 to FIG. 11, FIG. 13, and FIG. 17, the third contact hole opening 129 is opened (step 21 (S21) in FIG. 14). The third contact hole opening 129 opens the insulating layers 131 and 136 to expose the conductive layer 132. For example, the third contact hole opening 129 exposes the first wiring. The other third contact hole openings also expose the respective insulating layers, wirings or electrodes.

The conductive layer 142 (see FIG. 11 to FIG. 13) is formed over the insulating layer 131 (see FIG. 11 to FIG. 13) and in the third contact hole opening 129 (step 22 (S22) in FIG. 14). For example, as shown in FIG. 10, the conductive layers 140 include the second electrode 142A (the second electrode 44 and the first electrode 52). The second electrode 142A is electrically connected to the first wiring 132K via the third contact hole opening 129 and is electrically connected to the sixth transistor T6 via the first contact hole opening 135J. In the same manner as the second electrode 142A, the other conductive layers 140 are electrically connected to the corresponding first wirings and electrically connected to the corresponding gate wirings or transistors.

The insulating layer 141 (organic insulating layer) (see FIG. 11 to FIG. 13) is formed on the conductive layer 142 and on the insulating layer 131 on which the conductive layer 142 is not formed (step 23 (S23) in FIG. 14).

Further, the insulating layer 141 (organic insulating layer) (see FIG. 12) is opened (step 24 (S24) in FIG. 14). In the opening of S24, the contact hole opening 147A for the anode is opened. The contact hole opening 147A for the anode removes the insulating layers 141 and 131 on the first electrode 140C to expose the first electrode 140C. The contact hole opening 147A for the anode may be referred to as an organic insulating layer opening.

The anode 143 (see FIG. 10 and FIG. 12) is provided over the exposed first electrode 140C, over the contact hole opening 147A for the anode, and over the insulating layers 141 and 131 (step 25 (S25) of FIG. 14). The functional layer 148 (see FIG. 12) is also provided on the anode 143. The cathode 149 (see FIG. 12) is provided over the functional layer 148. For example, the anode 143 may be provided for each pixel, the functional layer 148 may be provided for each pixel, and the cathode 149 may be provided so as to overlap the display area 22.

After S25, the sealing film 165 is provided over the cathode 149 and the cover film 158 is provided over the sealing film 165 (see FIG. 12). That is, the sealing film 165 and the cover film 158 are provided on the cathode 149 in this order (see FIG. 12).

As described above, the manufacturing of the display device 10 (pixel 180) is completed.

Methods for manufacturing the display device 10 (pixel 180) include forming the conductive layer 127 along the first direction D1 and forming the conductive layer 132 along the second direction D2. In addition, the method for manufacturing the display device 10 (pixel 180) includes forming the conductive layer 140 and forming the conductive layer 142. The wirings that are routed through the display device 10 are mainly formed by the conductive layer 127 and the conductive layer 132, and the capacitive elements CV and CD and the anode 143 are formed by using the conductive layer 140 or the conductive layer 142. That is, in the method for manufacturing the display device 10 (the pixel 180), the formation of the lead wiring and the formation of the capacitive element can be performed using different wirings or electrodes. Therefore, in the method for manufacturing the display device 10 (pixel 180), the capacitive elements CV and CD included in the pixels and the capacitive elements CV and CD included in the adjacent pixels can be arranged at positions as close as possible. As a result, in the method for manufacturing the display device 10 (the pixel 180), capacitance values of the capacitive elements CV and CD can be made larger than in the case where the formation of the lead wiring and the formation of the capacitive elements are not formed using mutually-different wiring lines or electrodes. In addition, since the capacitance values of the capacitive elements CV and CD can be increased, it is possible to suppress a decrease in the holding voltage or a loss in the holding voltage.

As shown in FIG. 10, in a plan view, an area of the second electrode 142A is larger than an area of the first electrode 140A and an area of the first electrode 140B. Therefore, for example, as shown in a side wall portion 190 of FIG. 11, the capacitance of the capacitive element can be increased by a side wall of the first electrode 140B and a side wall of the second electrode 142A in an end face view. As a result, it is possible to suppress a decrease in the holding potential or a loss in the holding potential.

Further, as shown in FIG. 10, the capacitive elements CV and CD are spaced apart from the image data signal line 321 in a plan view. Consequently, fluctuations in the potentials held in the capacitive elements CV and CD due to the potential fluctuations of the image data signal lines 321 are suppressed.

### 1-8. Material of Each Member of Display Device 10

As the substrate 101, a rigid substrate having a light-transmitting property and no flexibility, such as a glass substrate, a quartz substrate, or a sapphire substrate, can be used. Further, in the case where the substrate 101 needs to have flexibility, a flexible substrate including a resin such as a polyimide substrate, an acrylic substrate, a siloxane substrate, or a fluorine resin substrate can be used as the substrate 101. In order to improve the heat resistance of a substrate SUB, the resin may be doped with impurities.

For example, the semiconductor layer 122 includes channel regions and includes Group 14 elements such as silicon (Si), germanium (Ge), or an oxide exhibiting semiconductor properties. As the oxide exhibiting semiconductor characteristics, a metal oxide having semiconductor 5 characteristics can be used. For example, as described in the section “1-7. Method for Manufacturing Display Device 10”, the semiconductor layer 122 includes an oxide semiconductor as a metal oxide exhibiting semiconductor characteristics. For example, the oxide semiconductor includes two or more metals including indium (In). Further, in addition to indium, gallium (Ga), zinc (Zn), aluminum (Al), hafnium (Hf), yttrium (Y), zirconia (Zr), and lanthanoids may be used as the metal oxide having semiconductive properties. Further, the metal oxide having semiconductor properties may be amorphous, may be crystalline, or may be a mixed phase of amorphous and crystalline.

Further, for example, the semiconductor layer 122 including the Group 14 element may include crystalline silicon. The crystalline silicon may be low-temperature polysilicon (LTPS) or single-crystal silicon. Further, the crystalline silicon is implanted with impurities. In the case where the transistor is an n-channel field-effect transistor, an impurity (for example, phosphorus (P)) is implanted so that the crystalline silicon becomes an n-type, and in the case where the transistor is a p-channel field-effect transistor, an impurity (for example, boron (B)) is implanted so that the crystalline silicon becomes a p-type. In addition, the channel regions of the transistors included in the display device 10 may be formed using single-crystal silicon such as a silicon wafer or a SOI substrate.

In addition, in the case where the display device 10 includes both a transistor including a Group 14 element and a transistor including an oxide exhibiting semiconductor characteristics as the semiconductor layer 122 (channel region), the method for manufacturing the display device 10 includes forming a semiconductor layer including the Group 14 element and forming a semiconductor layer (for example, an oxide semiconductor layer) including the oxide exhibiting semiconductor characteristics.

For example, the leakage current of a transistor including a metal oxide having semiconductor characteristics is extremely small. Therefore, by using a transistor having a metal oxide having semiconductor characteristics, a charge corresponding to the potential written in the capacitive element is less likely to escape from the capacitive element. As a result, by using a transistor having a metal oxide having semiconductor characteristics, it is possible to hold the charge written in the capacitive element for a long time. In addition, when the gate-source potential difference (the potential difference between the gate electrode and the source electrode) and the source-drain potential difference are the same, the drain current of the transistor having the metal oxide having the semiconductor property may be larger than the drain current of the transistor having the crystalline silicon (for example, low-temperature polysilicon (LTPS)). As a result, under the same condition of the drain current, the gate-source potential difference and the source-drain potential difference of the transistor having the metal oxide having the semiconductor characteristics can be made smaller than those of the transistor having the crystalline silicon. Therefore, by using a transistor having a metal oxide having semiconductor characteristics, power consumption of the display device 10 can be suppressed.

A general metal material is used as the conductive layer 127, the conductive layer 132, the conductive layer 140, and the conductive layer 142. For example, aluminum (Al), titanium (Ti), chromium (Cr), cobalt (Co), nickel (Ni), molybdenum (Mo), hafnium (Hf), tantalum (Ta), tungsten (W), bismuth (Bi), silver (Ag), copper (Cu), and alloys or compounds thereof are used as general metal materials. In addition, depending on the application and specifications of the display device 10, each conductive layer may include a structure in which the metal material is a single layer, and may include a structure in which the metal material is laminated.

A general insulating material can be used as a material for forming the base layer 121, the gate insulating layer 125, the insulating layer 131, the first inorganic insulating layer 152, and the second inorganic insulating layer 156. For example, inorganic insulating layers such as silicon oxide (SiOₓ), silicon oxynitride (SiOₓN_{y}), silicon nitride (SiNₓ), and silicon nitride oxide (SiNₓO_{y}) are used as the insulating layers. SiOₓN_{y} is a silicon compound and an aluminum compound which contain a smaller proportion (x>y) of nitrogen (N) than oxygen (O). SiNₓO_{y} is a silicon compound and an aluminum compound which contain a smaller proportion of oxygen than nitrogen (x>y). In addition, the insulating layer 131 may be formed using a high-dielectric material (a high-k material) having a higher dielectric constant.

For example, as a material for forming the insulating layer 128, the insulating layer 136, the insulating layer 141, and the organic insulating layer 154, an organic compound material having excellent surface flatness can be used. The insulating layer 128, the insulating layer 136, and the insulating layer 141 may be referred to as an organic insulating layer.

As a material forming the cathode 149, a conductive oxide that transmits visible light is used. For example, the cathode 149 may be formed of a mixture of indium oxide and tin oxide (ITO) or a mixture of indium oxide and zinc oxide (IZO). A material other than the above may be used as the conductive oxide that transmits visible light.

As a material for forming the anode 143, a metal having a high reflectance or an alloy thereof is used. For example, the anode 143 may be formed of a metal such as silver (Ag), aluminum (Al), or magnesium (Mg), or an alloy thereof. The material forming the cathode 149 may include a structure in which a film containing a metal is sandwiched between the films containing the conductive oxide described above.

### 2. Second Embodiment

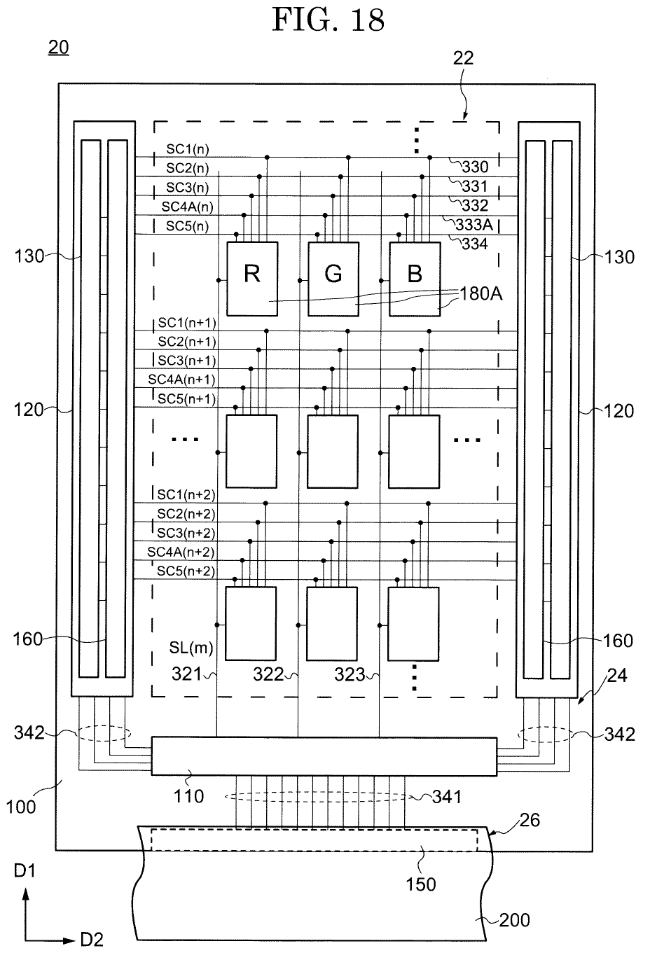

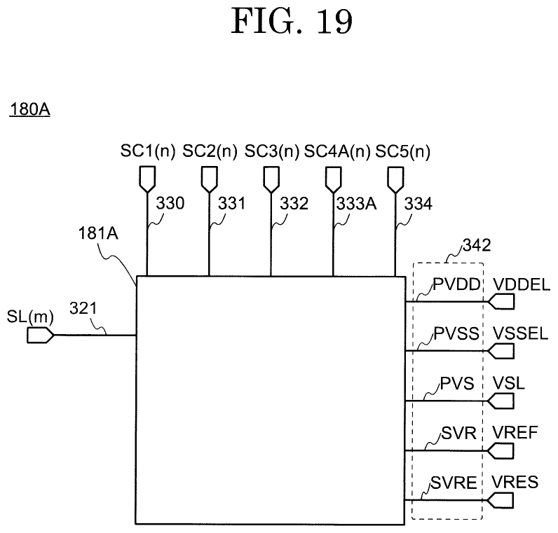

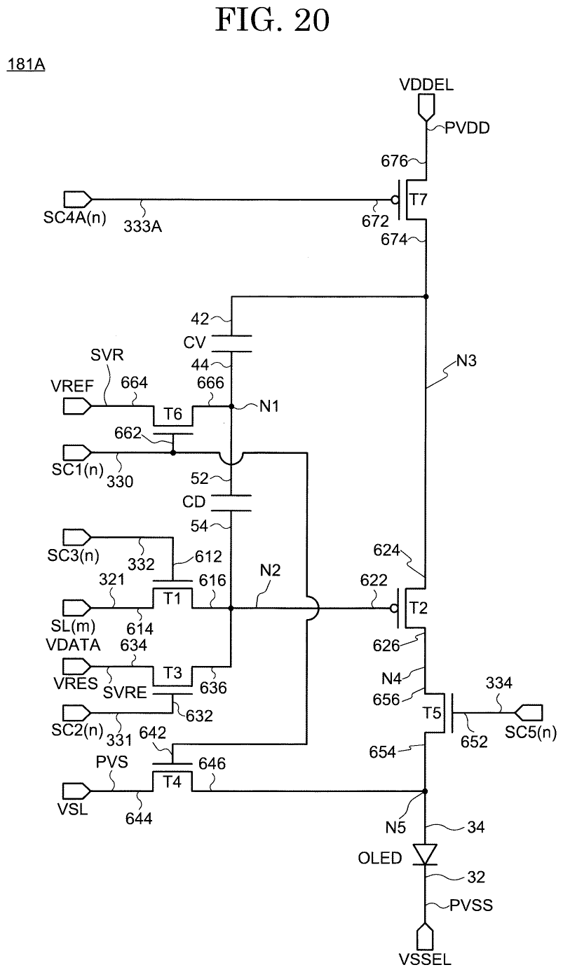

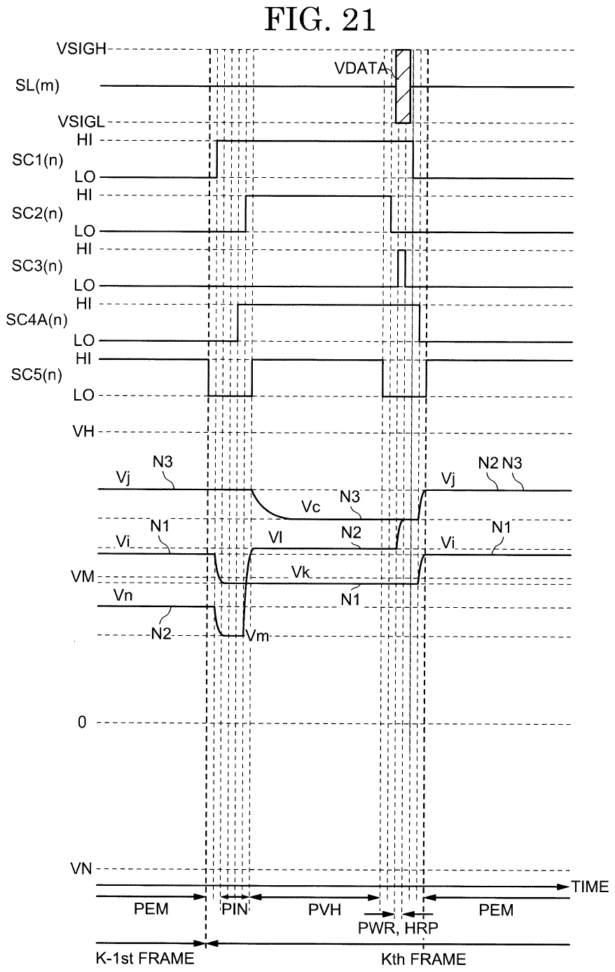

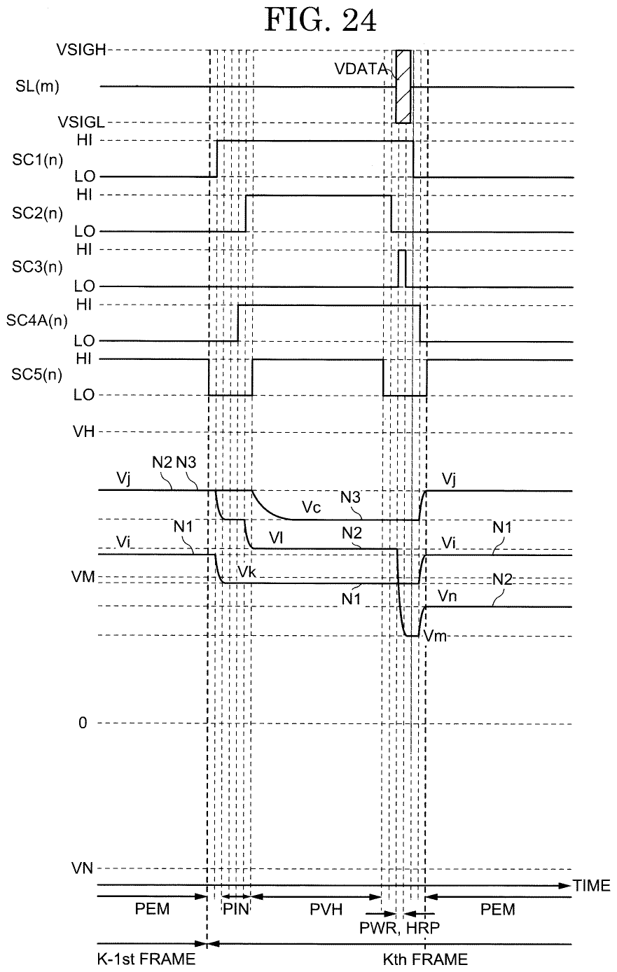

With reference to FIG. 4, FIG. 18, and FIG. 24, an overview of a display device 20 according to a second embodiment will be described. FIG. 18 is a schematic diagram showing a configuration of the display device 20. FIG. 19 is a schematic diagram showing an input signal to a pixel 180A (the pixel circuit 181A) according to the second embodiment, FIG. 20 is a circuit diagram showing a configuration of the pixel circuit 181A, and FIG. 21 to FIG. 24 are timing charts of the display device 20. Configurations that are the same as or similar to those in FIG. 1 to FIG. 17 will be described as necessary, and descriptions of the same or similar configurations as those in FIG. 1 to FIG. 17 may be omitted.

The display device 20 includes the pixel 180A and the pixel circuit 181A. Configurations of the pixel 180A and the pixel circuit 181A differ from the configurations of the pixel 180 and the pixel circuit 181 of the display device 10 according to the first embodiment. Specifically, the display device 20 includes the following configurations 1 to 6. Mainly, the configurations 1 to 6 and configurations related to the configurations 1 to 6 are different from the configuration of the display device 10 according to the first embodiment.
(Configuration 1) A configuration and function in which the pixel 180 (pixel circuit 181) of the display device 10 according to the first embodiment is replaced with the pixel 180A (pixel circuit 181A), and a configuration and function related to the pixel 180A (pixel circuit 181A) differ from the configuration and the function related to the pixel 180 (pixel circuit 181).
(Configuration 2) The electrical connection between the control circuit 120 and the pixel 180A (pixel circuit 181A) differs from the electrical connection between the control circuit 120 and the pixel 180 (pixel circuit 181).
(Configuration 3) The scan signal line 333 to which the scan signal SC4 (n) of the first embodiment is replaced with the scan signal line 333A to which the scan signal SC4A is supplied, and timing of the falling and rising of the scan signal SC4A differs from that of the first embodiment.
(Configuration 4) The initialization potential VINI and the initialization potential line SVI to which the initialization potential VINI is supplied are not included.
(Configuration 5) A constant potential VSL and the constant potential line PVS to which the constant potential VSL is supplied are included.
(Configuration 6) A seventh transistor T7 is included, and the second transistor T2 and the seventh transistor T7 are p-channel field-effect transistors.

The configurations other than the configurations 1 to 6 in the display device 20 and the configurations other than the configurations related to the configurations 1 to 6 in the display device 20 are the same as those of the display device 10 according to the first embodiment. In describing the configuration and function of the display device 20, the same configuration and function as those of the display device 10 are described as necessary, and description of the same configuration and function as those of the display device 10 may be omitted.

### 2-1. Configuration of Pixel 180A

Referring to FIG. 18 to FIG. 20, an overview of the pixel 180A and the pixel circuit 181A will be described.

As described in the above configurations 1 to 5, the display device 20 includes a scan signal line 333A to which the scan signal SC4A is supplied, the constant potential VSL, and the constant potential line PVS to which the constant potential VSL are supplied. The pixel circuit 181A is electrically connected to the scan signal lines 330 to 332 and 334, the drive potential line PVDD, the standard potential line PVSS, the reset potential line SVRE and the reference potential line SVR, and the scan signal line 333A and the constant potential line PVS, which are similar to those of the pixel circuit 181. On the other hand, as described in the above configurations 1 to 5, the display device 20 does not include the scan signal SC4(n) and the scan signal line 333 to which the scan signal SC4(n) is supplied, and does not include the initialization potential VINI and the initialization potential line SVI to which and the initialization potential VINI is supplied. The scan signal lines 330 to 332 and 334 and the scan signal line 333A in the display device 20 extend in the second direction D2 from the control circuit 120 and are connected to the plurality of pixels 180 arranged in the second direction D2.

For example, the constant potential line PVS is electrically connected to the connection wiring 342 that differs from the reset potential line SVRE, the reference potential line SVR, the drive potential line PVDD, and the standard potential line PVSS. Further, for example, the constant potential line PVS may be the connection wiring 342 that differs from the reset potential line SVRE, the reference potential line SVR, the drive potential line PVDD, and the standard potential line PVSS.

For example, in the same manner as the reset potential VRES, the reference potential VREF, the driving potential VDDEL, and the standard potential VSSEL, the constant potential VSL is supplied to the IC chip 110 via the FPC 200, the terminal portion 150, and the connection wiring 341 from the external device, and may be supplied to the plurality of pixels 180A (pixel circuits 181A) from the IC chip 110 via the constant potential line PVS, or, the constant potential VSL is generated in the IC chip 110, and may be supplied to the plurality of pixels 180A (pixel circuits 181A) from the IC chip 110 via the constant potential line PVS. In addition, although not shown, the constant potential VSL may be connected from an external device to the constant potential line PVS via the FPC 200, the terminal portion 150, and the connection wiring 341 without passing through the IC chip 110 and the connection wiring 342, and may be supplied to the plurality of pixels 180A (pixel circuits 181A). For example, the constant potential VSL is the same potential as the driving potential VDDEL.

As shown in FIG. 20, the pixel 180A (pixel circuit 181A) includes the first transistor T1, the second transistor T2, the third transistor T3, the fourth transistor T4, the fifth transistor T5, the sixth transistor T6, the seventh transistor T7, the capacitive element CD, and the light-emitting element OLED. Each of these transistors includes a gate electrode and a pair of electrodes (a source electrode and a drain electrode) including a first electrode and a second electrode. Each of the capacitive element CV, the capacitive element CD, and the light-emitting element OLED has a pair of electrodes including a first electrode and a second electrode. In addition, the capacitive element CV may be referred to as a first capacitive element, and the capacitive element CD may be referred to as a second capacitive element.

The fourth transistor T4 has a function of conducting the fifth node N5 and the constant potential line PVS, supplying the constant potential VSL to the fifth node N5, making the potential supplied to the first electrode 32 and the potential supplied to the second electrode 34 of the light-emitting element OLED the same, and stopping the light emission of the light-emitting element OLED in the period PIN, the period PVH, and the period PWR.

The fifth transistor T5 has a function of conducting the fourth node N4 and the fifth node N5.

The second transistor T2 includes the gate electrode 622, the first electrode 624, and the second electrode 626. The first electrode 624 is electrically connected to the third node N3, the first electrode 42 of the capacitive element CV, and a first electrode 674 of the seventh transistor T7. The second electrode 626 is electrically connected to the fourth node N4 and the second electrode 656 of the fifth transistor T5. The threshold voltage of the second transistor T2 is the threshold voltage VTH, but is −1 V (setting value). The second transistor T2 controls the current flowing through the light-emitting element OLED in accordance with the potential difference Vgs and the potential difference Vds between the potential supplied to the second electrode 626 (the fourth node N4) and the potential supplied to the first electrode 624 (the third node N3). For example, if the potential difference Vgs is smaller than the threshold voltage VTH (higher than −1 V when expressed by the gate potential Vg of the source potential Vs standard), the second transistor T2 becomes non-conductive. In this case, since no current flows through the light-emitting element OLED, the pixel 180 displays black. For example, if the potential Vgs (hereinafter referred to as the gate potential Vg with respect to the source potential Vs) is lower than the threshold voltage VTH and the potential Vds (hereinafter referred to as the drain potential Vd with respect to the source potential Vs) is lower than 0 V, the second transistor T2 is in a conductive state, the current flowing to the light-emitting element OLED is controlled in accordance with the magnitude of the potential difference Vgs based on the display gradation, and the light-emitting element OLED emits light with a brightness based on the display gradation.

The fourth transistor T4 includes the gate electrode 642, the first electrode 644, and the second electrode 646. The gate electrode 642 is electrically connected to the gate electrode 662 of the sixth transistor T6 and the scan signal line 330. The first electrode 644 is electrically connected to the constant potential line PVS. The second electrode 646 is electrically connected to the fifth node N5, the first electrode 654 of the fifth transistor T5, and the second electrode 34 of the light-emitting element OLED. The fourth transistor T4 is switched using the first scan signal SC1(n). In other words, the fourth transistor T4 is controlled to be in the conductive state (on state) or the non-conductive state (off state) by the first scan signal SC1(n). If the signal supplied to the first scan signal SC1(n) is LO, the fourth transistor T4 becomes non-conductive, and if the signal supplied to the first scan signal SC1(n) is HI, the fourth transistor T4 becomes conductive.

The seventh transistor T7 includes a gate electrode 672, the first electrode 674, and a second electrode 676. The gate electrode 672 is electrically connected to the scan signal line 333A. The second electrode 676 is electrically connected to the driving potential line PVDD. The seventh transistor T7 is switched using a fourth scan signal SC4A(n). In other words, in the seventh transistor T7, the conduction state (on state) and the non-conduction state (off state) are controlled by the fourth scan signal SC4A(n). If the signal supplied to the fourth scan signal SC4A(n) is HI, the seventh transistor T7 becomes non-conductive, and if the signal supplied to the fourth scan signal SC4A(n) is LO, the seventh transistor T7 becomes conductive.

A driving method of the display device 20 includes obtaining the threshold voltage VTH by applying the constant potential VSL from the second electrode 626 (drain electrode) of the second transistor T2 via the constant potential line PVS.

As described in the configuration 6 described above, the second transistor T2 and the seventh transistor T7 are p-channel transistors. The first transistor T1, the third transistor T3 to the sixth transistor T6 shown in FIG. 20 are n-channel field-effect transistors. The channel region of the second transistor T2 and the channel region of the seventh transistor T7 include p-type crystalline silicon. For example, the p-type crystalline silicon is implanted with impurities (for example, boron (B)) so that the crystalline silicon becomes p-type. Each of the channel regions of the first transistor T1, the third transistor T3 to the sixth transistor T6 includes the same configuration as that of the first embodiment. Further, for example, each transistor in the display device 20 is formed using a thin film transistor (TFT) in the same manner as each transistor in the display device 10. In the same manner as the display device 10, the display device 20 may appropriately adapt the configuration of the transistor, the connection of the storage capacitive element, the power supply potential, and the like according to the application and the specification.

The configurations and the functions of the pixel 180A (pixel circuit 181A) other than the configurations and the functions described in the section “2-1. Configuration of Pixel 180A” are the same as those of the pixel 180 (pixel circuit 181).

### 2-2. Drive Method of Pixel Circuit 181A

A driving method of the display device 20 will be described with reference to FIG. 21 to FIG. 24. Configurations that are the same as or similar to those in FIG. 1 to FIG. 20 will be described as necessary. The horizontal axis of the timing charts indicates time (TIME).

The driving method of the display device 20 includes a period similar to the driving method of the display device 10 according to the first embodiment shown in FIG. 4.

In one horizontal period (horizontal period HRP) in the driving method of the display device 20, the pixel 180A (pixel circuit 181A) is input with the data signal SL(m) including the first scan signal SC1(n), the second scan signal SC2(n), the third scan signal SC3(n), the fourth scan signal SC4A(n), the fifth scan signal SC5(n), and the image data signal VDATA, the constant potential VSL, the reset potential VRES, and the reference potential VREF. For example, the pixel 180A (pixel circuit 181A) is selected according to timings of the first scan signal SC1(n), the second scan signal SC2(n), the third scan signal SC3(n), the fourth scan signal SC4A(n), and the fifth scan signal SC5(n). The image data signal SL(m) is input to the selected pixel 180A (pixel-circuit 181A) in accordance with the timings of the respective signals. A similar operation is performed on all the pixels 180A (pixel circuits 181A), and an image of the corresponding frame corresponding to 1 FRAME is displayed in the display area 22 of the display device 10 on the basis of the image data signal SL(m) input to all the pixels 180A (pixel circuits 181A).

For example, the signals of each frame and the potentials supplied to each node in the timing charts shown in FIG. 21 to FIG. 24 are shown in Table 2.

TABLE 2

| | Setting value [V] |
|---|---|
| VTH | −1 |
| VDDEL | 8 |
| VSSEL | 0 |
| HI | 10 |
| LO | −2 |
| VRES | 6 |
| VREF | 4.8 |
| VSL | 0 |
| VSIGL(black) | 7 |
| VSIGH(white) | 3 |

For example, as shown in Table 2, the threshold voltage VTH of the second transistor T2 is −1 V, the reset potential VRES is 6 V, the reference potential VREF is 4.8 V, and the constant potential VSL is 0 V. The potential VSIGH is 7 V, and the pixel 180 to which the potential VSIGH is supplied does not emit light and becomes black. Further, for example, the potential VSIGL is 3 V, and the pixel 180 to which the potential VSIGL is supplied emits light and emits white color. The other setting values of the potentials are the same as the setting values shown in Table 1 described in the section “1-5. Driving Method of Display Device 10”. In addition, similar to the respective potentials in the display device 10, the respective potentials in the display device 20 shown in Table 2 are examples, and the respective potentials in the display device 20 are not limited to the respective potentials shown in Table 2. Each potential of the display device 20 can be appropriately selected according to the application and specifications of the display device 20.

### 2-2-1. First Example of Driving Method of Display Device 20

Referring to FIG. 21 and Table 2, a first example of the driving method of the display device 20 will be described. The first example of the driving method of the display device 20 includes displaying images of different colors in consecutive frames as in the first example of the driving method of the display device 10 according to the first embodiment. Configurations that are the same as or similar to those in FIG. 1 to FIG. 20 will be described as necessary.

As in the first example of the driving method of the display device 10 according to the first embodiment, the image data signal SL(m) including the data signal VDATA is input to each pixel 180A (pixel circuit 181A) in accordance with each period. The data signal VDATA is analog data including a potential that is equal to or greater than the potential VSIGL and equal to or less than the potential VSIGH. For example, in the period PWR, the potential supplied to the selected pixel 180A (pixel circuit 181A) is supplied to the image data signal SL(m). For example, in a period excluding the period PWR, the data signal VDATA is supplied with a potential supplied to pixels other than the selected pixel 180A (pixel circuit 181A).

For example, in the light emitting period PEM of the K−1st FRAME, the image data signal SL(m) (data signal VDATA) is supplied with the potential of the data signal VDATA supplied to pixels other than the selected pixel 180A (pixel circuit 181A), the first scan signal SC1(n), the second scan signal SC2(n), the third scan signal SC3(n), and the fourth scan signal SC4A(n) are supplied with LO, and the fifth scan signal SC5(n) is supplied with HI. The first transistor T1, the third transistor T3, the fourth transistor T4, and the sixth transistor T6 are in the off state, and the fifth transistor T5 and the seventh transistor T7 are in the on state. Further, for example, in this case, a potential held at the first node N1 is a potential Vi (for example, 5.8 V), a potential held at the second node N2 is a potential Vn (for example, 4.0 V), a potential held at the third node N3 is a potential Vj (for example, 8 V), and the potential difference Vgs is the potential Vn−potential Vj (for example, −4 V). Therefore, the second transistor T2 is in the on state, and the current Ion based on the potential difference Vgs and the potential difference Vds corresponding to the potential VSIGL (for example, 3 V) input during the horizontal period HRP of the K−1st FRAME can be passed from the driving potential line PVDD to the light emitting element OLED and the reference potential line PVSS. Consequently, the light-emitting element OLED emits light. For example, the pixel 180A (pixel circuit 181A) emits red light, and three pixels using the pixel 180A that emits red light, the pixel 180A that emits blue light, and the pixel 180A that emits green light emit white light. In addition, the potential held at the first node N1 is the potential Vi due to capacitive coupling by the capacitive element CV and the capacitive element CD.

In a period between the light emitting period PEM of the K−1st FRAME and the period PIN of the Kth FRAME following the light emitting period PEM of the K−1st FRAME, the potential of the data signal VDATA supplied to pixels other than the pixel 180A (pixel circuit 181A) is supplied to the image data signal SL(m) (data signal VDATA). First, the fifth scan signal SC5(n) changes from the state where HI is supplied to the state where LO is supplied. If the fifth scan signal SC5(n) is supplied with LO, the first scan signal SC1(n) changes from the state where LO is supplied to the state where HI is supplied.

Consequently, in the period between the light emitting period PEM of the K−1st FRAME and the period PIN of the Kth FRAME, the fifth transistor T5 is turned from the on state to the off state, and after the fifth transistor T5 is turned to the off state, the fourth transistor T4 and the sixth transistor T6 are turned from the off state to the on state. The first transistor T1 and the third transistor T3 remain in the off state, and the second transistor T2 and the seventh transistor T7 remain in the on state. Therefore, the third node N3 is electrically connected to the driving potential line PVDD, and the third node N3 is supplied with the driving potential VDDEL (8 V). Since the third node N3 is supplied with the potential Vj (8 V), the potential supplied to the third node N3 continues to maintain the potential Vj. Further, the fifth node N5 is electrically connected to the constant potential line PVS, and the potential supplied to the fifth node N5 drops toward the constant potential VSL (0 V) and becomes the constant potential VSL. Therefore, the light emission of the light-emitting element OLED is stopped by the potential difference between the first electrode 32 and the second electrode 34 of the light-emitting element OLED becoming zero, and the current Ion no longer flows from the driving potential line PVDD to the light-emitting element OLED. Further, the first node N1 conducts with the reference potential line SVR, and the potential supplied to the first node N1 drops from the potential Vi toward a potential Vk (the reference potential VREF, 4.8 V), and becomes the potential Vk (the reference potential VREF, 4.8 V). Here, since the first transistor T1 and the third transistor T3 are maintained in the off state, the second node N2 is in the floating state, and by capacitive coupling between the first node N1 and the second node N2 by the capacitive element CD, the potential supplied to the second node N2 drops from the potential Vn to a potential Vm corresponding to the voltage drop (potential difference between potential Vi and potential Vk) of the first node N1.

As described above, in the period between the light emitting period PEM of the K−1st FRAME and the period PIN of the Kth FRAME, the potential Vk (reference potential VREF) is supplied to the first node N1, the potential Vm is supplied to the second node N2, and the potential supplied to the third node N3 maintains the potential Vj.

In the period PIN of the Kth FRAME following the period between the light emitting period PEM of K−1st FRAME and the period PIN of the Kth FRAME, the potential of the data signal VDATA supplied to pixels other than the selected pixel 180A (pixel circuit 181A) is supplied to the image data signal SL(m) (data signal VDATA). The fourth scan signal SC4A(n) changes from the state where LO is supplied to the state where HI is supplied. If the fourth scan signal SC4A(n) is supplied with HI, the second scan signal SC2(n) changes from the state where HI is supplied to the state where LO is supplied. The first scan signal SC1(n) remains in the state where HI is supplied, and the third scan signal SC3(n) and the fifth scan signal SC5(n) remain in the state where LO is supplied.

Consequently, the seventh transistor T7 is turned from the on state to the off state and after the seventh transistor T7 is turned from the off state, the third transistor T3 is turned from the off state to the on state. Since the sixth transistor T6 remains in the on state, the potential supplied to the first node N1 maintains the potential Vk. In addition, since the fourth transistor T4 remains in the on state, the potential supplied to the fifth node N5 remains 0 V. Until the seventh transistor T7 is in the off state, the third node N3 is supplied with the driving potential VDDEL, the third node N3 is initialized by the driving potential VDDEL, and when the seventh transistor T7 is in the off state, the third node N3 is cut off from the driving potential line PVDD. When the third transistor T3 is turned on, the second node N2 conducts with the reset potential line SVRE, and the potential supplied to the second node N2 gradually rises from the potential Vm toward a potential Vl (reset potential VRES, 6 V) and becomes the potential Vl. Although the potential Vgs of the second transistor T2 is lower than the threshold voltage VTH, the current Ion does not flow because the seventh transistor T7 and the fifth transistor T5 are in the off state. Since the potential difference between the first electrode 32 and the second electrode 34 of the light-emitting element OLED is zero, the light-emitting element OLED does not emit light, in the same manner as the period between the light-emitting period PEM of the K−1st FRAME and the period PIN of the Kth FRAME.

As described above, in the period PIN, the first node N1 is initialized by the reference potential VREF, the second node N2 is initialized by the reset potential VRES, and the third node N3 is initialized by the drive potential VDDEL.

In the period PVH following the period PIN, the image data signal SL(m) (data signal VDATA) is supplied with the potential of the data signal VDATA supplied to pixels other than the selected pixel 180A (pixel circuit 181A), the fifth scan signal SC5(n) changes from the state where LO is supplied to the state where HI is supplied, and the fifth transistor T5 is turned from the off state to the on state. The other scan signals and the other transistors are in the same condition as the period PIN.

Consequently, in the period PVH, the first node N1 maintains the potential Vk and the second node N2 maintains the potential Vl. At the beginning of the period PVH, the potential difference Vgs is 2 V and the second transistor T2 is in the on state. Since the second transistor T2, the fifth transistor T5, and the fourth transistor T4 are in the on state, the third node N3, the fourth node N4, and the fifth node N5 are conducted, and the electrode Ion flows from the third node N3, the fourth node N4, and the fifth node N5 to the constant potential line PVS. The potential supplied to the third node N3 has been released, and the potential of the third node N3 starts to gradually drop from the potential Vj at a timing when the fifth transistor T5 changes from the off state to the on state. When the potential Vgs reaches the threshold voltage VTH (−1 V), the second transistor T2 is turned off. At this time, the potential supplied to the third node N3 is the potential Vc (the potential Vl is −1 V with respect to the potential Vc). Therefore, in the driving method of the display device 10, the threshold voltage VTH can be acquired by operating in the period PVH, and the acquired threshold voltage VTH can be held. Further, since the driving method includes applying the correction to the second transistor T2 with the acquired threshold voltage VTH in the period after the period PVH, the driving method of the display device 10 can realize the correction of the threshold voltage VTH by operating in the period PVH in the driving method of the display device 20. In addition, in practice, although the threshold voltage VTH varies in manufacturing, in the same manner as the configuration described in the section “1-5-1. First Example of Driving Method of Display Device 10”, the first example of the driving method of the display device 20 includes that the potential supplied to the respective nodes by the operation in the period PVH becomes a potential corresponding to the threshold voltage VTH that varies in manufacturing, and that the threshold voltage VTH that varies in manufacturing is obtained and correction is performed using the obtained threshold voltage VTH. Consequently, in the first example of the driving method of the display device 20, it is possible to correct the threshold voltage VTH by operating the period PVH in the same manner as in the configuration described in the section “1-5-1. First Example of Driving Method of Display Device 10”.

As described above, in the period PVH, by the operation in which the potential difference Vgs of the second transistor T2 becomes the same as the threshold voltage VTH, the threshold voltage VTH of the second transistor T2 is acquired, and charges corresponding to the threshold voltage VTH are held in the capacitive element CV.

In the period between the period PVH and the period PWR following the period PVH, the potential of the data signal VDATA supplied to the image data signal SL(m) (data signal VDATA) other than the selected pixel 180A (pixel circuit 181A) is supplied. First, the fifth scan signal SC5(n) changes from the state where HI is supplied to the state where LO is supplied. If the fifth scan signal SC5(n) is supplied with LO, the second scan signal SC2(n) changes from the state where HI is supplied to the state where LO is supplied. Therefore, the fifth transistor T5 and the third transistor T3 are turned from the on state to the off state. The other control signals and the other transistors are in the same condition as the period PVH. The potential supplied to the first node N1 maintains the potential Vk, the potential supplied to the second node N2 maintains the potential Vl, the potential supplied to the third node N3 maintains the potential Vc, and the potential difference Vgs is 1 V. Since the fourth transistor T4 remains in the on state and the potential difference between the first electrode 32 and the second electrode 34 of the light-emitting element OLED is zero, the light-emitting element OLED does not emit light. Further, the fifth transistor T5 is turned off, and the current Ion does not flow from the third node N3, the fourth node N4, and the fifth node N5 to the constant potential line PVS.

In the period PWR following the period between the period PVH and the period PWR, the image data signal SL(m) (the data signal VDATA) is supplied with the potential VSIGH (7 V). The third scan signal SC3(n) changes from the state where LO is supplied to the state where HI is supplied, and the first transistor T1 is turned from the off state to the on state. The other control signals and the other transistors are in the same condition as the period PVH. The potential supplied to the first node N1 maintains the potential Vk, and the potential supplied to the third node N3 maintains the potential Vc. Since the first transistor T1 is turned from the off state to the on state, the second node N2 is electrically connected to the image data signal line 321, and the potential supplied to the second node N2 gradually increases from the potential Vl toward the potential VSIGH (potential Vc, 7 V), and becomes the potential Vc. In this case, the capacitive element CD maintains the potential difference (2.2 V with reference to the potential supplied to the first node N1) by holding a charge corresponding to the potential difference between Vk (reference potential VREF, 4.8 V) supplied to the first node N1 and the potential Vc (7 V) supplied to the second node N2). Further, the capacitive element CV maintains the potential difference (−2.2 V with reference to a potential supplied to the third node N3) by holding charges corresponding to the potential difference between Vk (the reference potential VREF, 4.8 V) supplied to the first node N1 and the potential Vc (7 V) supplied to the third node N3. A sum (2.2 V−2.2 V) of the potential difference held in the capacitive element CD and the potential difference held in the capacitive element CV is 0 V, that is, the potential difference Vgs is 0 V. Therefore, the second transistor T2 is in the off state. In addition, in the same manner as the period between the period PVH and the period PWR, the light-emitting element OLED does not emit light in the period PWR.

As described above, in the period PWR, the data signal VDATA is written to the pixel 180A (pixel circuit 181A). The capacitive element CD maintains (holds) the data potential of the data signal VDATA.

During a period after the period PWR, the third scan signal SC3(n) changes from the state where HI is supplied to the state where LO is supplied. If the third scan signal SC3(n) is supplied with LO, the first scan signal SC1(n) changes from the state where HI is supplied to the state where LO is supplied. If the first scan signal SC1(n) is supplied with LO, the fourth scan signal SC4A(n) changes from the state where HI is supplied to the state where LO is supplied. The first transistor T1, the fourth transistor T4, and the sixth transistor T6 are turned from the on state to the off state, and the seventh transistor T7 is turned from the off state to the on state. The other scan signals and the other transistors are the same as the period PWR. Since the seventh transistor T7 is turned on, the third node N3 is electrically connected to the driving potential line PVDD (8 V), and the potential supplied to the third node N3 gradually increases from the potential Vc toward the potential Vj (driving potential VDDEL, 8 V), and becomes the potential Vj (driving potential VDDEL, 8 V). The first transistor T1, the fourth transistor T4, and the sixth transistor T6 are in the off state, and the first node N1 and the second node N2 are in the floating state. Since the potential supplied to the third node N3 is changed from the potential Vc to the potential Vj, the potential supplied to the first node N1 is increased from the potential Vk to the potential Vi by capacitive coupling (capacitive element CV) between the third node N3 and the first node N1. Further, the potential supplied to the second node N2 increases from the potential Vc to the potential Vj by capacitive coupling (capacitive element CD) between the first node N1 and the second node N2. Since the fourth transistor T4 and the fifth transistor T5 are in the off state, the current Ion does not flow to the constant potential VSL and the light-emitting element OLED, and the light-emitting element OLED does not emit light.

Consequently, in a period after the period PWR, the potential supplied to the first node N1 capacitively coupled by the capacitive element CV and the capacitive element CD becomes the potential Vi, and the potential supplied to the second node N2 and the potential supplied to the third node N3 become the potential Vj. In this case, the potential difference Vgs is 0 V, and the second transistor T2 is in the off state.

In the light emitting period PEM of the Kth FRAME following the period PWR of the Kth FRAME, the potential of the data signal VDATA supplied to pixels other than the selected pixel 180A (pixel circuit 181A) is supplied to the image data signal SL(m) (data signal VDATA). Further, the fifth scan signal SC5(n) changes from the state where LO is supplied to the state where HI is supplied. Therefore, the fifth transistor T5 is turned from the off state to the on state. The other scan signals and the other transistors are in the same condition as the period after the period PWR of the Kth FRAME.

Consequently, the fifth transistor T5 is turned on, and the second electrode 34 (the fifth node N5) of the light-emitting element OLED is electrically connected to the second electrode 626 (the fourth node N4) of the second transistor T2. Since the seventh transistor T7 is in the on state and the third node N3 is electrically connected to the driving potential line PVDD, the potential supplied to the third node N3 maintains the driving potential VDDEL. Further, the potential supplied to the second node N2 maintains the potential Vj by the capacitive coupling between the capacitive element CD and the capacitive element CV. The first node N1 maintains the potential Vi by the capacitive coupling of the capacitive element CD and the capacitive element CV. The potential difference Vgs is the sum of the potential difference held in the capacitive element CD and the potential difference held in the capacitive element CV (reference potential VREF (4.8 V)−(reset potential VRES (6 V)−threshold voltage VTH (−1 V))+the potential of the data signal VDATA (potential VSIGH, 7 V)−reference potential VREF (4.8 V)=0 V. In the pixel 180A (pixel circuit 181A) in which the data signal VDATA includes the potential VSIGL, since the potential difference Vgs is 0 V and the second transistor T2 is in the off state, the current Ion does not flow. Therefore, the light-emitting element OLED does not emit light. Consequently, the pixel 180A (pixel circuit 181A) that emits red light, the pixel 180A (pixel circuit 181A) that emits blue light, and the pixel 180A (pixel circuit 181A) that emits green light do not emit light, so that the pixels 180A become black in three pixels using the pixel 180A that emits red light, the pixel 180A that emits blue light, and the pixel 180A that emits green light.

The display device 20 including the configuration described above has the same operational effects as those described in the display device 10.

In addition, the display device 20 includes the seventh transistor T7 and the second transistor T2 of the p-channel type, and the fifth transistor T5 of the n-channel type. Further, the driving method of the display device 20 includes that movement of the charge of the third node N3 in the period PEM is based on the operation of the p-channel type field effect transistor (the seventh transistor T7), and that movement of the charge of the fifth node N5 in the period PEM is based on the operation of the n-channel type field effect transistor (the fifth transistor T5). Therefore, the driving method of the display device 20 can control the potential supplied to the third node N3 and the potential supplied to the fifth node N5 by using transistors of mutually differing polarities in the period PEM. Therefore, the potential supplied to the second electrode 672 of the seventh transistor T7 and the potential supplied to the second electrode 652 of the fifth transistor T5 when transitioning to the period PEM are opposite to each other. That is, the signal supplied to the fourth scan signal SC4A(n) changes from HI to LO, the signal supplied to the gate electrode 672 of the seventh transistor T7 changes from HI to LO, while the signal supplied to the fifth scan signal SC5(n) changes from LO to HI, and the signal supplied to the gate electrode 652 of the fifth transistor T5 changes from LO to HI. As a consequence, the variation in the potential applied from the gate electrode to the third node N3 and the fifth node N5 can be cancelled out by capacitive coupling, and the loss of the holding voltage due to the decrease in the write potential in the period PEM can be suppressed to a minimum.

### 2-2-2. Second Example of Driving Method of Display Device 20

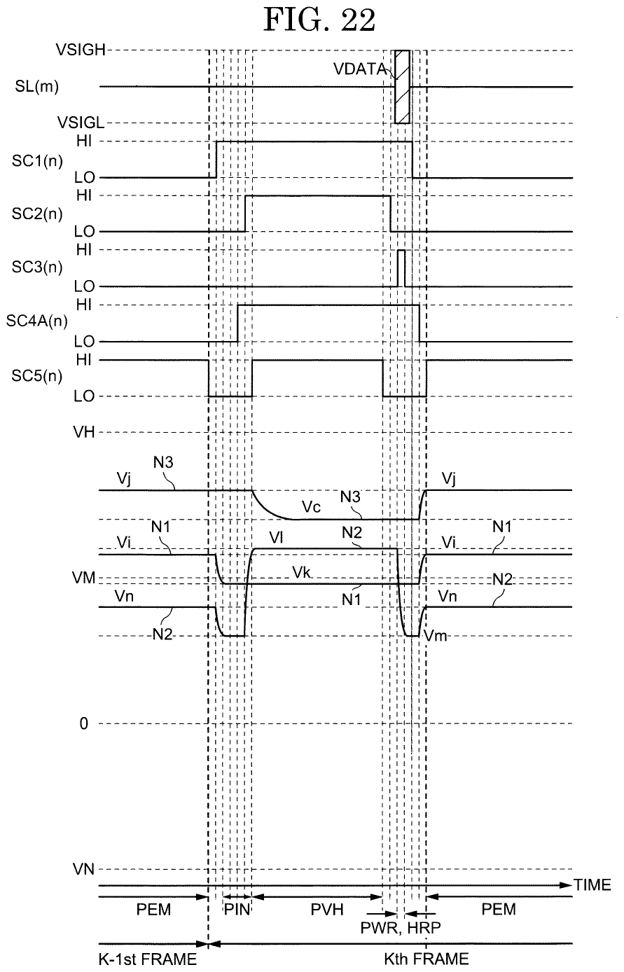

A second example of the driving method of the display device 20 will be described with reference to FIG. 22. The driving method shown in the second example of the display device 20 includes displaying an image of the same color (white color) in consecutive frames as in the second example of the driving method of the display device 10 according to the first embodiment. Configurations that are the same as or similar to those in FIG. 1 to FIG. 21 will be described as necessary.

The potential of the respective nodes in the light emitting period PEM of the K−1th FRAME to the period PVH of the Kth FRAME and the period between the period PVH of the Kth FRAME and the period PWR of the Kth FRAME are the same as those described in the section “2-2-1. First Example of Driving Method of Display Device 20”. Further, the configuration of each scan signal and the operation of each transistor in each period are the same as the configuration described in the section “2-2-1. First Example of Driving Method of Display Device 20”. Therefore, configurations and the like similar to those described in the section “2-2-1. First Example of Driving Method of Display Device 20” will be described as necessary. In addition, the image data signal SL(m) is supplied with the data signal VDATA including the potential VSIGL (potential Vm, 3 V) corresponding to white in the period PWR of the Kth FRAME, and is supplied with the same data signal VDATA as the configuration described in the section “2-2-1. First Example of Driving Display Device 20” in the period other than the period PWR of the Kth FRAME.

In the light emitting period PEM of the K−1st FRAME, in the same manner as the configuration described in the section “2-2-1. First Example of Driving Method of Display Device 20”, the pixel 180A emits white light in three pixels using a pixel 180A that emits red light, a pixel 180A that emits blue light, and a pixel 180A that emits green light.

In the period between the light emitting period PEM of the K−1st FRAME and the period PIN of the Kth FRAME, as in the configuration described in the section “2-2-1. First Example of Driving Method of Display Device 20”, the first node N1 is supplied with the potential Vk (reference potential VREF), the second node N2 is supplied with the potential Vm (potential VSIGL, 3 V), and the potential supplied to the third node N3 maintains the potential Vj.

In the period PIN of the Kth FRAME, the first node N1 is initialized by the reference potential VREF, the second node N2 is initialized by the reset potential VRES, and the third node N3 is initialized by the drive potential VDDEL, in the same manner as the configuration described in the section “2-2-1. First Example of Driving Method of Display Device 20”.

In the period PVH following the period PIN, by the operation in which the potential difference Vgs of the second transistor T2 becomes the same as the threshold voltage VTH, the threshold voltage VTH of the second transistor T2 is acquired and the charges corresponding to the threshold voltage VTH are held in the capacitive element CV, in the same manner as the configuration described in the section “2-2-1. First Example of Driving Method of Display Device 20”. In addition, in practice, although the threshold voltage VTH varies in manufacturing, in the same manner as the configuration described in the section “2-2-1. First example of the driving methods of the display device 20”, the second example of the driving method of the display device 20 includes that the potential supplied to the respective nodes by the operation in the period PVH becomes a potential corresponding to the threshold voltage VTH that varies in manufacturing, and that the threshold voltage VTH that varies in manufacturing is obtained and correction is performed using the obtained threshold voltage VTH. Consequently, in the second example of the driving method of the display device 20, it is possible to correct the threshold voltage VTH by operating the period PVH in the same manner as the configuration described in the section “2-2-1. First Example of Driving Method of Display Device 20”.

In the period between the period PVH and the period PWR following the period PVH, in the same manner as the configuration described in the section “2-2-1. First Example of Driving Method of Display Device 20”, the potential supplied to the first node N1 maintains the potential Vk, the potential supplied to the second node N2 maintains the potential Vl, the potential supplied to the third node N3 maintains the potential Vc, and the potential Vgs is −1 V.

In the period PWR following the period between the period PVH and the period PWR, the image data signal SL(m) (data signal VDATA) is supplied with the potential VSIGL (potential Vm, 3 V). The potential supplied to the first node N1 maintains the potential Vk, and the potential supplied to the third node N3 maintains the potential Vc. The potential supplied to the second node N2 gradually increases from the potential Vl toward the potential Vm, and becomes the potential Vm (potential VSIGL, 3 V). In this case, the capacitive element CD maintains the potential difference (−1.8 V with reference to the potential supplied to the first node N1) by holding a charge corresponding to the potential difference between Vk (reference potential VREF, 4.8 V) supplied to the first node N1 and the potential Vm (3 V) supplied to the second node N2. Further, the capacitive element CV maintains the potential difference (−2.2 V with reference to the potential supplied to the third node N3) by holding a charge corresponding to the potential difference between Vk supplied to the first node N1 and the potential Vc (7 V) supplied to the third node N3. A sum (−1.8 V−2.2 V) of the potential difference held in the capacitive element CD and the potential difference held in the capacitive element CV is −4 V, and the potential difference Vgs is −4 V. Therefore, the second transistor T2 is in the on state.

As described above, in the period PWR, the data signal VDATA is written to the pixel 180A (pixel circuit 181A). Further, the capacitive element CD maintains (holds) the data potential of the data signal VDATA.

In the period after the period PWR, the seventh transistor T7 is turned on, so that the third node N3 is electrically connected to the driving potential line PVDD, and the potential supplied to the third node N3 gradually increases from the potential Vc toward the driving potential VDDEL (8 V), and becomes the driving potential VDDEL (8 V). The sixth transistor T6 is in the off state, and the first node N1 and the second node N2 are in the floating state. Therefore, the potential supplied to the third node N3 becomes the driving potential VDDEL (8 V), so that the potential supplied to the first node N1 increases from the potential Vk to the potential Vi by capacitive coupling between the first node N1 and the third node N3. Further, the potential supplied to the second node N2 increases from the potential Vm to the potential Vn by capacitive coupling between the second node N2 and the first node N1 by the capacitive element CD.

In the light emitting period PEM of the Kth FRAME following the period after the period PWR of the Kth FRAME, the potential supplied to the third node N3 remains 8 V. Further, the potential supplied to the second node N2 maintains the potential Vn by the capacitive coupling between the capacitive element CD and the capacitive element CV. The first node N1 also maintains the potential Vi by the capacitive coupling of the capacitive element CV. The potential difference Vgs is a sum of the potential difference held in the capacitive element CD and the potential difference held in the capacitive element CV (reference potential VREF (4.8 V)−(reset potential VRES (6 V)−threshold voltage VTH (−1 V))+the potential of the data signal VDATA (potential VSIGL, 3 V)−reference potential VREF (4.8 V)=−4 V). In the pixel 180A (pixel circuit 181A) in which the data signal VDATA includes the potential VSIGL, the current Ion flows from the driving potential line PVDD to the light-emitting element OLED and the standard potential line PVSS, and the light-emitting element OLED emits light, since the potential difference Vgs is −4 V and the second transistor T2 is in the on state. For example, the pixel 180A that emits red light, the pixel 180A that emits blue light, and the pixel 180A that emits green light emit light respectively, and three pixels using the pixel 180A that emits red light, the pixel 180A that emits blue light, and the pixel 180A that emits green light become white.

The second example of the driving method of the display device 20 has the same effects as those described in the section “2-2-1. First Example of Driving Method of Display Device 20”. Further, in the display device 20 and the driving method of the display device 20, since the light-emitting element OLED is arranged on the drain side of the second transistor T2, the potential supplied to the gate electrode 622 of the second transistor T2 and the potential supplied to the first electrode 624 in the period PWR can be set to be close to the potential supplied to the gate electrode 622 of the second transistor T2 and the potential supplied to the first electrode 624 in the period PEM. Therefore, the display device 20 and the driving method of the display device 20 can suppress the power consumed in the light emitting period PEM from the period PWR, and can suppress the charge redistribution caused by gate capacitance of the second transistor T2 (capacitance between the gate electrode 622 and the second electrode 624) due to the potential variation of the second node N2. As a result, in the display device 20 and the driving method of the display device 20, it is possible to minimize the voltage loss by which the write voltage decreases during light emission.

### 2-2-3. Third Example of Driving Method of Display Device 20

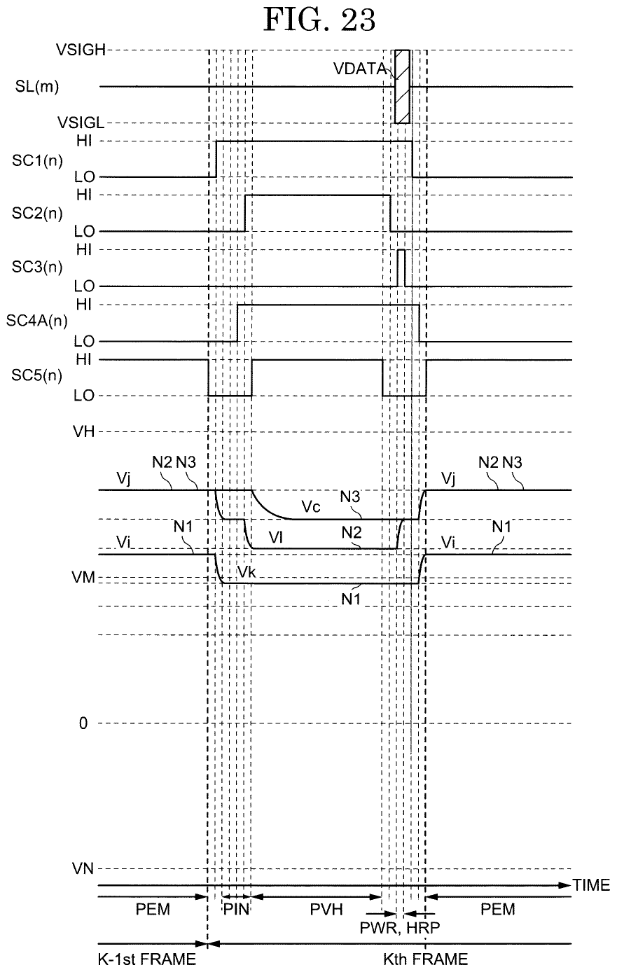

A third example of the driving method of the display device 20 will be described with reference to FIG. 23. The driving method shown in the third example of the driving method of the display device 20 includes displaying images of the same color (black) in consecutive frames as in the third example of the driving method of the display device 10 according to the first embodiment. Configurations that are the same as or similar to those in FIG. 1 to FIG. 22 will be described as necessary.

The potentials and the like of the respective nodes in the light emitting period PEM of the Kth FRAM to the period PVH of the Kth FRAME are the same as those described in the section “2-2-1. First Example of Driving Method of Display Device 20”. Further, the configuration of each scan signal and the operation of each transistor in each period are the same as the configuration described in the section “2-2-1. First Example of Driving Method of Display Device 20”. Therefore, configurations and the like similar to those described in the section “2-2-1. First Example of Driving Method of Display Device 20” will be described as necessary.

In the light emitting period PEM of the K−1st FRAME, for example, the potential supplied to the first node N1 is the potential Vi. The potential supplied to the second node N2 and the potential supplied to the third node N3 are the potential Vj (8 V), and the potential difference Vgs is 0 V. Therefore, the second transistor T2 is in the off state, the current Ion does not flow, and the light-emitting element OLED does not emit light.

Consequently, since the pixel 180A (the pixel circuit 181A) that emits red, the pixel 180A that emits blue, and the pixel 180A that emits green do not emit light, the pixel 180A becomes black in three pixels using the pixel 180A that emits red, the pixel 180A that emits blue, and the pixel 180A that emits green.

In the period between the light emitting period PEM of the K−1st FRAME and the period PIN of the Kth FRAME following the light emitting period PEM of the K−1st FRAME, the potential supplied to the third node N3 continues to maintain the potential Vj since the third node N3 has been supplied with the driving potential VDDEL (8 V). Further, although the current Ion does not flow from the driving potential line PVDD to the light-emitting element OLED and the standard potential line PVSS, and the light emission of the light-emitting element OLED is stopped, the first node N1 becomes conductive to the reference potential line SVR, and the potential supplied to the first node N1 drops toward the potential Vk (the reference potential VREF, 4.8 V) from the potential Vi and becomes the potential Vk. Since the first transistor T1 and the third transistor T3 remain in the off state, the second node N2 is in the floating state, and the potential supplied to the first node N1 is lowered to the potential Vk (reference potential VREF, 4.8 V), so that the potential supplied to the second node N2 is changed from the potential Vj to the potential Vc due to capacitive coupling by the capacitive element CD between the first node N1 and the second node N2.

As described above, in the period between the light emitting period PEM of the K−1st FRAME and the period PIN of the Kth FRAME, the first node N1 is supplied with the potential Vk (reference potential VREF), the second node N2 is supplied with the potential Vc, and the third node N3 is supplied with the potential Vj.

In the period PIN of the Kth FRAME following the period between the period PIN of the Kth FRAME, the potential supplied to the first node N1 maintains the potential Vk (reference potential VREF). While the seventh transistor T7 is in the on state, the potential supplied to the third node N3 maintains the driving potential VDDEL (that is, is initialized). When the seventh transistor T7 is turned off and the third transistor T3 is turned on, the second node N2 is electrically connected to the reset potential line SVRE, and the potential supplied to the second node N2 gradually drops from the potential Vc toward the reset potential VRES (potential Vl, 6 V) to become the potential Vl. Although the potential Vgs of the second transistor T2 is lower than the threshold voltage VTH, since the seventh transistor T7 and the fifth transistor T5 are in the off-state, the current Ion does not flow. In addition, the fourth transistor T4 is in the on state, the potential supplied to the second electrode 34 remains 0 V, and the potential difference between the first electrode 32 and the second electrode 34 of the light-emitting element OLED is zero, so that the light-emitting element OLED does not emit light.

As described above, in the period PIN, the first node N1 is initialized by the reference potential VREF, the second node N2 is initialized by the reset potential VRES, and the third node N3 is initialized by the drive potential VDDEL.

In the period PVH following the period PIN, in the same manner as the configuration described in the section “2-2-1. First Example of Driving Method of Display Device 20”, the threshold voltage VTH of the second transistor T2 is acquired by the operation in which the potential difference Vgs of the second transistor T2 becomes the same as the threshold voltage VTH, and charges corresponding to the threshold voltage VTH are held in the capacitive element CV. In addition, in practice, although the threshold voltage VTH varies in manufacturing, in the same manner as the configuration described in the section “2-2-1. First Example of Driving Method of Display Device 20”, the third example of the driving method of the display device 20 includes that the potential supplied to the respective nodes by the operation in the period PVH becomes a potential corresponding to the threshold voltage VTH that varies in manufacturing, and that the threshold voltage VTH that varies in manufacturing is obtained and the correction is performed using the obtained threshold voltage VTH. As a consequence, the third example of the driving method of the display device 20 can correct the threshold voltage VTH by operating the period PVH in the same manner as the configuration described in the section “2-2-1. First Example of Driving Method of Display Device 20”.

In the period between the period PVH and the period PWR following the period PVH, in the same manner as the configuration described in the section “2-2-1. First Example of Driving Method of Display Device 20”, the potential supplied to the first node N1 maintains the potential Vk, the potential supplied to the second node N2 maintains the potential Vl, the potential supplied to the third node N3 maintains the potential Vc, and the potential difference Vgs is −1 V.

In the period PWR following the period between the period PVH and the period PWR, the data signal VDATA is written to the pixel 180A (pixel circuit 181A) in the period PWR in the same manner as in the configuration described in the section “2-2-1. First Example of Driving Method of Display Device 20”. The capacitive element CD maintains (holds) the data potential of the data signal VDATA.

In the period after the period PWR, in the same manner as the configuration described in the section “2-2-1. First Example of Driving Method of Display Device 20”, the potential supplied to the first node N1 capacitively coupled by the capacitive element CV becomes the potential Vi, and the potential supplied to the second node N2 and the potential supplied to the third node N3 become the potential Vj. In this case, the potential difference Vgs is 0 V, and the second transistor T2 is in the off state.

In the light emitting period PEM of the Kth FRAME following the period after the period PWR, as in the configuration described in the section “2-2-1. First Example of Driving Method of Display Device 20”, the potential difference Vgs is 0 V and the second transistor T2 is in the off state, so that the electrode Ion does not flow and the light-emitting element OLED does not emit light. Consequently, the pixels 180A become black in three pixels using the pixel 180A that emits red, the pixel 180A that emits blue, and the pixel 180A that emits green.

The third example of the driving method of the display device 20 has the same effects as those described in the section “2-2-1. First Example of Driving Method of Display Device 20”.

[2-2-4. Fourth Example of Driving Method of Display Device 20]A fourth example of the driving method of the display device 20 will be described with reference to FIG. 24. The driving method shown in the fourth example of the driving method of the display device 20 includes displaying images of different colors in consecutive frames as in the fourth example of the driving method of the display device 10 according to the first embodiment. Configurations that are the same as or similar to those in FIG. 1 to FIG. 23 will be described as necessary.

The potential of each node, the configuration of each scan signal, the operation of each transistor, and the like in the light emitting period PEM of the K−1st FRAME to the period PVH of the Kth FRAME are the same as those described in the section “2-2-3. Third Example of Driving Method of Display Device 20”. Further, the potential of each node, the configuration of each scan signal, the operation of each transistor, and the like in the period after the period PVH of the Kth FRAME to the light emitting period PEM of the Kth FRAME are the same as those described in the section “2-2-2. Second Example of Driving Method of Display Device 20”. Therefore, the description thereof will be omitted.

The fourth example of the driving method of the display device 20 has the same effects as those described in the section “2-2-1. First Example of Driving Method of Display Device 20”.

As the embodiment of the present invention, each of the embodiments described above or a part of each of the embodiments described above can be appropriately combined as long as they do not conflict with each other.

It is to be understood that the present invention provides other functional effects that are different from the operational effects provided by the aspects of the embodiments described above, and those that are obvious from the description of the present specification or those that can be easily predicted by a person skilled in the art.

What is claimed is:

1. A pixel circuit comprising:
a first transistor;
a second transistor;
a sixth transistor;
a first capacitive element;
a second capacitive element;
a light-emitting element;
an image data signal line supplied with a data potential; and
a reference potential line supplied with a reference potential,
wherein
the first transistor is controlled by a first control signal and is electrically connected between the image data signal line and a gate electrode of the second transistor,
the second transistor is electrically connected to a first electrode of the first capacitive element,
the sixth transistor is controlled by a second control signal and is electrically connected between the reference potential line and a first electrode of the second capacitive element,
the first capacitive element is electrically connected between the first electrode of the second capacitive element and a first electrode of the second transistor, and
the second capacitive element is electrically connected between a second electrode of the first capacitive element and the gate electrode of the second transistor.

2. The pixel circuit according to claim 1, wherein
the light-emitting element is electrically connected between a standard potential line supplied with a standard potential and the first electrode of the second transistor.

3. The pixel circuit according to claim 2, further comprising:
a fifth transistor;
a third transistor;
a fourth transistor;
a driving potential line supplied with a driving potential which is higher than the standard potential;
a reset potential line supplied with a reset potential; and
an initialization potential line supplied with an initialization potential;
wherein
the fifth transistor is controlled by a third control signal, and is electrically connected between the reset potential line and a second electrode of the second transistor,
the third transistor is controlled by a fourth control signal, and electrically connected between the reset potential line and the gate electrode of the second transistor, and
the fourth transistor is controlled by a fifth control signal, and is electrically connected between the initialization potential line and the first electrode of the second transistor.

4. The pixel circuit according to claim 3, wherein
the first transistor to the sixth transistor are n-channel type field effect transistors.

5. The pixel circuit according to claim 3, wherein
each channel region of the first transistor to the sixth transistor includes an oxide semiconductor.

6. The pixel circuit according to claim 1, further comprising:
a fifth transistor; and
a standard potential line supplied with a standard potential,
wherein
the fifth transistor is controlled by a third control signal, and is electrically connected between a second electrode of the second transistor and a second electrode of the second capacitive element, and
the light-emitting element is electrically connected between the standard potential line and a first electrode of the fifth transistor.

7. The pixel circuit according to claim 6, further comprising:
a third transistor;
a fourth transistor;
a seventh transistor;
a reset potential line supplied with a reset potential;
a constant potential line supplied with a constant potential; and
a driving potential line supplied with a driving potential which is higher than the standard potential;
wherein
the third transistor is controlled by a fourth control signal, and electrically connected between the reset potential line and the gate electrode of the second transistor,
the fourth transistor is controlled by the first control signal, and is electrically connected between the constant potential line and the first electrode of the fifth transistor, and
the seventh transistor is controlled by a fifth control signal, and is electrically connected between the driving potential line and the first electrode of the second transistor.

8. The pixel circuit according to claim 7, wherein
the first transistor, the third transistor to the sixth transistor are n-channel type field effect transistors, and
the second transistor and the seventh transistor are p-channel type field effect transistors.

9. The pixel circuit according to claim 8, wherein
each channel region of the first transistor, the third transistor to the sixth transistor includes an oxide semiconductor, and
each channel region of the second transistor and the seventh transistor includes crystalline silicon.

10. A display device including a plurality of pixels including the pixel circuit according to claim 3, wherein
the plurality of pixels is arranged in a matrix in a first direction and a second direction intersecting the first direction.

11. The display device according to claim 10, further comprising a control circuit that outputs the first control signal to the fifth control signal, wherein
the control circuit is configured to be capable of controlling the first capacitive element to hold a potential difference corresponding to a threshold voltage of the second transistor, and then to hold a potential difference corresponding to the data potential in the second capacitive element.

12. The display device according to claim 11, wherein
the control circuit is configured to be able to control,
before holding the potential difference corresponding to the threshold voltage of the second transistor in the first capacitive element, turning off the first transistor using the first control signal, turning off the third transistor using the fourth control signal, turning off the fifth transistor using the third control signal, turning on the sixth transistor using the second control signal, turning on the fourth transistor using the fifth control signal, supplying the reference potential to the first electrode of the second capacitive element and supplying the initialization potential to the first electrode of the second transistor, and
before holding the potential difference corresponding to the threshold voltage of the second transistor in the first capacitive element and after the reference potential is supplied to the first electrode of the second capacitive element, turning off the fourth transistor using the fifth control signal, turning on the third transistor using the fourth control signal, and supplying the reset potential to the second electrode of the second capacitive element.

13. The display device according to claim 12, wherein
the control circuit is configured to be able to control,
after supplying the reset potential to the second electrode of the second capacitive element,
turning on the fifth transistor using the third control signal, and
holding a potential difference corresponding to the threshold voltage of the second transistor in the first capacitive element.

14. The display device according to claim 11, wherein
the control circuit is configured to be able to control,
after holding a potential difference corresponding to the threshold voltage of the second transistor in the first capacitive element,
turning off the fifth transistor using the third control signal,
turning off the third transistor using the fourth control signal,
turning on the first transistor using the first control signal,
supplying the data potential to the second electrode of the second capacitive element,
turning off the first transistor using the first control signal, and
holding a potential difference corresponding to the data potential in the second capacitive element.

15. A display device including a plurality of pixels including the pixel circuit according to claim 7, wherein
the plurality of pixels is arranged in a matrix in a first direction and a second direction intersecting the first direction.

16. The display device according to claim 15, further comprising a control circuit that outputs the first control signal to the fifth control signal, wherein
the control circuit is configured to be capable to control holding a potential difference corresponding to the threshold voltage of the second transistor in the first capacitive element, and then holding a potential difference corresponding to the data potential in the second capacitive element.

17. The display device according to claim 16, wherein
the control circuit is configured to be able to control,
before holding the potential difference corresponding to the threshold voltage of the second transistor in the first capacitive element, turning off the first transistor using the first control signal, turning on the seventh transistor using the fifth control signal, turning off the third transistor using the fourth control signal, turning off the fifth transistor using the third control signal, turning on the sixth transistor and the fourth transistor using the second control signal, supplying the reference potential to the first electrode of the second capacitive element, and supplying the constant potential to the first electrode of the fifth transistor,
before holding the potential difference corresponding to the threshold voltage of the second transistor in the first capacitive element and after the reference potential is supplied to the first electrode of the second capacitive element and the constant potential is supplied to the first electrode of the fifth transistor, turning off the seventh transistor using the fifth control signal, turning on the third transistor using the fourth control signal, and supplying the drive potential to the first electrode of the second transistor, and
before holding the potential difference corresponding to the threshold voltage of the second transistor in the first capacitive element and after stopping the supply of the drive potential to the first electrode of the second transistor, turning on the third transistor using the fourth control signal, and supplying the reset potential to the second electrode of the second capacitive element.

18. The display device according to claim 17, wherein
the control circuit is configured to be able to control,
after supplying the reset potential to the second electrode of the second capacitive element,
turning on the fifth transistor using the third control signal, and
holding a potential difference corresponding to the threshold voltage of the second transistor in the first capacitive element.

19. The display device according to claim 18, wherein
the control circuit is configured to be able to control,
after holding the potential difference corresponding to the threshold voltage of the second transistor in the first capacitive element,
turning off the fifth transistor using the third control signal,
turning off the third transistor using the fourth control signal,
turning on the first transistor using the first control signal,
supplying the data potential to the second electrode of the second capacitive element,
turning off the first transistor using the first control signal, and
holding a potential difference corresponding to the data potential in the second capacitive element.
